(19) United States
(12) Patent Application Publication
(10) Pub. No.: US 2014/0301333 A1
(43) Pub. Date: Oct. 9, 2014

(54) RECEPTION DEVICE, RECEPTION METHOD, AND WIRELESS COMMUNICATION SYSTEM

(71) Applicant: Sharp Kabushiki Kaisha, Osaka-shi, Osaka (JP)

(72) Inventors: Hiroki Takahashi, Osaka-shi (JP); Yasuhiro Hamaguchi, Osaka-shi (JP); Kazunari Yokomakura, Osaka-shi (JP); Osamu Nakamura, Osaka-shi (JP); Jungo Goto, Osaka-shi (JP)

(73) Assignee: Sharp Kabushiki Kaisha, Osaka-shi, Osaka (JP)

(21) Appl. No.: 14/353,820

(22) PCT Filed: Oct. 30, 2012
(86) PCT No.: PCT/JP2012/077928

§ 371 Date: Apr. 24, 2014

(30) Foreign Application Priority Data
Nov. 2, 2011 (JP) 2011-241582

(51) Int. Cl. H04B 7/02; H04L 5/00

(52) U.S. Cl. CPC H04B 7/024; H04L 5/003
USPC 370/329

(57) ABSTRACT

A reception device is provided which can realize flexible frequency assignment to individual transmission devices in coordinated communication for receiving signals through coordination, while an influence caused by inter-user interference is reduced. In a reception device receiving a signal from a transmission device in coordination with at least one other reception device, the reception device includes a reception unit that receives the signal transmitted from the transmission device, a coordinated communication unit that, when a part of a frequency band of the signal transmitted from the transmission device is overlapped with a frequency band of a signal transmitted from another transmission device, receives from the other reception device a spectrum in at least a part of the overlapped frequency band of the signal transmitted from the transmission device, and a first reception processing unit that executes a reception process of the signal received by the reception device by employing the spectrum received by the coordinated communication unit.

### TECHNICAL FIELD

The present invention relates to a reception device, a reception method, a program, and a wireless communication system.

### BACKGROUND ART

Standardization of LTE-A (LTE-Advanced, called also IMT-A), which is a developed version of an LTE (Long Term Evolution) system, is being progressed as a wireless communication system for fourth-generation cellular phones.

In the LTE-A system, application of coordinated communication (also called “coordinated multi-point transmission and reception” or simply “CoMP”) to each of a downlink and an uplink is studied as a technique for improving a throughput at a cell edge, which is reduced by inter-cell interference (see Non Patent Literature (NPL) 1). The coordinated communication is a technique for, when data is transmitted and received between base stations and mobile stations, causing plural base stations to transmit and receive data through coordination. In the coordinated communication for the uplink, particularly, a signal transmitted from a mobile station is received by plural base stations, and the signals received by the individual base stations are combined with each other. As a result, transmission performance can be improved. The signals received by the plural base stations are shared by them via wired communication using optical fibers, for example.

FIG. 20 is a conceptual view illustrating the coordinated communication in uplink. In the case of uplink, the coordinated communication is also called JR-CoMP (Joint Reception CoMP) because plural base stations (reception points) receive a signal from the same mobile station device. In FIG. 20, there are base stations eNB1 and eNB2, which can share received data, etc. via wired communication using optical fibers, for example. Furthermore, there are mobile stations UE1 to UE3 each of which communicates with at least one of the base stations. The mobile stations UE1 to UE3 are each connected to the base station where power of the signal received from the relevant mobile station is maximal, by employing a synchronization signal. In FIG. 20, the mobile stations UE1 and UE2 are connected to the base stations eNB1 and eNB2, respectively. On the other hand, the base stations eNB1 and eNB2 receive the signal from the mobile station UE3 through coordination. Thus, the mobile station UE3 is connected to both the base stations eNB1 and eNB2. However, the mobile station UE3 is not always required to recognize all the base stations that take part in the coordinated communication. The mobile station UE3 may receive parameters, which are used by the mobile station to transmit data, as control information from only one particular base station.

LTE and LTE-A employ the Frequency Division Multiple Access (FDMA) technique of assigning, in a cell covered by a base station, frequency bands in frequency orthogonal relation between mobile stations. Therefore, the frequency band used in data transmission by the mobile station, which is connected to plural base stations carrying out the coordinated communication, is determined taking into account the usage conditions of frequency bands in all the coordinating base stations. FIG. 21 illustrates one example of frequency assignment in eNB1 and frequency assignment in eNB2 in the wireless communication system (FIG. 20) of related art. It is here assumed that a minimum assignment unit is defined as a “resource block (RB)”, and that frequency resources are assigned to each mobile station in units of RB.

In the example of FIG. 21, as denoted by a reference sign EA11, resource blocks RB1 and RB2 are assigned to the mobile station UE1 that transmits the signal to the base station eNB1. As denoted by a reference sign EA22, resource blocks RB1 and RB2 are also assigned to the mobile station UE2 that transmits the signal to the base station eNB2. On the other hand, as denoted by reference signs EA13 and EA23, resource blocks RB3 and RB4 are assigned to the mobile station UE3 that transmits the signal to both the base stations eNB1 and eNB2.

Thus, in the related-art wireless communication system such as illustrated in FIG. 20, the same frequency bands can be assigned to UE1 and UE2 that are connected to the different base stations. On the other hand, because a pair of UE1 and UE3 and a pair of UE1 and UE3 are connected to the same base station per pair, different frequency bands are assigned to the mobile stations of each pair.

### CITATION LIST

### Non-Patent Document

NPL 1: NTT DOCOMO, “Views for Rel. 11 CoMP”, 3GPPTSG-RAN WG1 #6 3bis R1-110248, Jan. 17, 2011

### DISCLOSURE OF THE INVENTION

### Problems to be Solved by the Invention

However, the coordinated communication in the uplink accompanies with the problem that flexibility in assignment of frequency bands is reduced because frequency resources are used corresponding to the number of base stations coordinating with each other. It is assumed, for example, that, as illustrated in FIG. 22, when assignable frequency bands (resource blocks) are 4RB, i.e., RB1 to RB4, exclusively different frequency bands are assigned as an assignment band PA1 to the mobile station UE1 transmitting the signal to the base stations eNB1, and as an assignment band PA2 to the mobile station UE2 transmitting the signal to the base stations eNB2. In such a case, there are no frequency bands where the mobile station UE3 can perform the coordinated communication while frequency orthogonality is maintained with respect to the other mobile station. Conversely, when RB3 and RB4 are preferentially assigned to the mobile station UE3 that performs the coordinated communication, the frequency bands assignable to the mobile station UE1 and the mobile station UE2 are only RB1 and RB2. Thus, a degree of freedom in frequency assignment is reduced.

The present invention has been made in view of the above-described situations, and an object of the present invention is to provide a reception device, a reception method, a program, and a wireless communication system, which can realize flexible assignment of frequency bands to individual transmission devices in coordinated communication for receiving signals through coordination.

### Means for Solving the Problems

(1) With the view of solving the above-mentioned problems, according to one aspect of the present invention, there is provided a reception device receiving a signal from a transmission device in coordination with at least one other reception device, the reception device comprising a reception unit that receives the signal transmitted from the transmission device, a coordinated communication unit that, when a part of a frequency band of the signal transmitted from the transmission device is overlapped with a frequency band of a signal transmitted from another transmission device, receives from the other reception device a spectrum in at least a part of the overlapped frequency band of the signal transmitted from the transmission device, and a first reception processing unit that executes a reception process of the signal received by the reception unit by employing the spectrum received by the coordinated communication unit.
(2) According to another aspect of the present invention, the above-described reception device further comprises a scheduling unit that determines a first frequency band used in transmission by the transmission device, wherein the scheduling unit determines the first frequency band to be not overlapped per assignment unit with one of a second frequency band used by the other transmission device transmitting the signal to the relevant reception device and a third frequency band used by the other transmission device transmitting a signal to the other reception device.
(3) According to still another aspect of the present invention, in any of the above-described reception devices, the first reception processing unit includes a spectrum combining unit that combines a spectrum of the signal received by the reception unit and the spectrum received by the coordinated communication unit.
(4) According to still another aspect of the present invention, in the above-described reception device, the first reception processing unit includes a replica generation unit that generates a replica of the signal transmitted from the transmission device based on the spectrum combined by the spectrum combining unit, and a cancellation unit that cancels an interference component of the signal received by the reception unit by employing the generated replica.
(5) According to still another aspect of the present invention, any of the above-described reception devices further comprises a second reception processing unit that executes a reception process of the signal transmitted from the other transmission device, wherein the reception unit receives, in addition to the signal transmitted from the transmission device, the signal transmitted from the other transmission device, the latter signal having the frequency band that includes a frequency band of the spectrum received by the coordinated communication unit, and the second reception processing unit includes an overlap cancellation unit that cancels the spectrum received by the coordinated communication unit from a spectrum of the signal received by the reception unit, the latter spectrum being a spectrum in the frequency band of the signal transmitted from the other transmission device.
(6) According to still another aspect of the present invention, in the above-described reception device, the first reception processing unit includes a replica generation unit that generates a replica of the signal transmitted from the transmission device based on the spectrum combined by the spectrum combining unit, and the second reception processing unit includes a cancellation unit that cancels an interference component of the spectrum of the signal received by the reception unit, the spectrum being the spectrum in the frequency band of the signal transmitted from the other transmission device, by employing the generated replica.
(7) According to still another aspect of the present invention, in any of the above-described reception devices, the other reception device exists plural, and the coordinated communication unit receives, from each of the plural other reception devices, at least a part of the spectrum in the overlapped frequency band of the signal transmitted from the transmission device.
(8) According to still another aspect of the present invention, there is provided a reception method for use in a reception device receiving a signal from a transmission device in coordination with at least one other reception device, the reception method comprising a first step of receiving the signal transmitted from the transmission device, a second step of, when a part of a frequency band of the signal transmitted from the transmission device is overlapped with a frequency band of a signal transmitted from another transmission device, receiving from the other reception device at least a part of a spectrum in the overlapped frequency band of the signal transmitted from the transmission device, and a third step of executing a reception process of the signal received in the first step by employing the spectrum received in the second step.
(9) According to still another aspect of the present invention, there is provided a program causing a computer in a reception device, which receives a signal from a transmission device in coordination with at least one other reception device, to function as a reception unit that receives the signal transmitted from the transmission device, a coordinated communication unit that, when a part of a frequency band of the signal transmitted from the transmission device is overlapped with a frequency band of a signal transmitted from another transmission device, receives from the other reception device a spectrum in at least a part of the overlapped frequency band of the signal transmitted from the transmission device, and a first reception processing unit that executes a reception process of the signal received by the reception unit by employing the spectrum received by the coordinated communication unit.
(10) According to still another aspect of the present invention, there is provided a wireless communication system comprising a first reception device and a second reception device both receiving a signal from a transmission device through coordination, wherein the first reception device comprises a first reception unit that receives the signal transmitted from the transmission device, and a first coordinated communication unit that transmits, to the second reception device, a partial spectrum in at least a part of a frequency band of the received signal, which is overlapped with a frequency band of a signal transmitted from another transmission device to the second reception device, and wherein the second reception device comprises a second reception unit that receives the signal transmitted from the transmission device, a second coordinated communication unit that receives the partial spectrum, and a reception processing unit that executes a reception process of the signal received by the second reception unit by employing the partial spectrum.

### Effects of the Invention

According to the present invention, flexible assignment of frequency bands to individual transmission devices can be realized in the case of carrying out the coordinated communication for receiving signals through coordination.

### BRIEF DESCRIPTION OF THE DRAWINGS

FIG. 1 is a schematic view illustrating a configuration of a wireless communication system 10 according to a first embodiment of the present invention.

FIG. 2 is a conceptual view illustrating an example of frequency band assignment in the first embodiment.

FIG. 3 illustrates a manner of separating spectra of individual mobile stations in a base station device according to the first embodiment.

FIG. 4 is a schematic block diagram illustrating a configuration of a mobile station device 11 according to the first embodiment.

FIG. 5 is a schematic block diagram illustrating a configuration of a base station device 12 according to the first embodiment.

FIG. 6 is a schematic block diagram illustrating a configuration of a reception unit 202 according to the first embodiment.

FIG. 7 is a schematic block diagram illustrating a configuration of a coordinated communication mode processing unit 207-1 according to the first embodiment.

FIG. 8 is a schematic block diagram illustrating a configuration of a non-coordinated communication mode processing unit 209-1 according to the first embodiment.

FIG. 9 is a flowchart to explain a frequency band assignment process in a scheduling unit 204 according to the first embodiment.

FIG. 10 is a conceptual view to explain a first process in an iterative equalization process according to a second embodiment of the present invention.

FIG. 11 is a conceptual view to explain a reception process for a spectrum of UE1 according to the second embodiment.

FIG. 12 is a conceptual view to explain a reception process for a spectrum of UE2 according to the second embodiment.

FIG. 13 is a conceptual view to explain a reception process for a spectrum of UE3 according to the second embodiment.

FIG. 14 is a schematic block diagram illustrating a configuration of a base station device 13 according to the second embodiment.

FIG. 15 is a schematic block diagram illustrating a configuration of a coordinated communication mode processing unit 701-1 according to the second embodiment.

FIG. 16 is a schematic block diagram illustrating a configuration of an iterative processing unit 702-1 according to the second embodiment.

FIG. 17 is a flowchart to explain a modification of the frequency band assignment process in a scheduling unit 204 according to the second embodiment.

FIG. 18 is a conceptual view illustrating a configuration of a wireless communication system 10b according to a third embodiment of the present invention.

FIG. 19 is a conceptual view illustrating one example of frequency band assignment in the third embodiment.

FIG. 20 is a schematic view illustrating a configuration of a wireless communication system of related art.

FIG. 21 is a conceptual view illustrating one example of frequency band assignment in eNB1 and frequency band assignment in eNB2 in the wireless communication system of related art.

FIG. 22 is a conceptual view illustrating another example of the frequency band assignment in eNB1 and the frequency band assignment in eNB2 in the wireless communication system of related art.

### BEST MODE FOR CARRYING OUT THE INVENTION

### First Embodiment

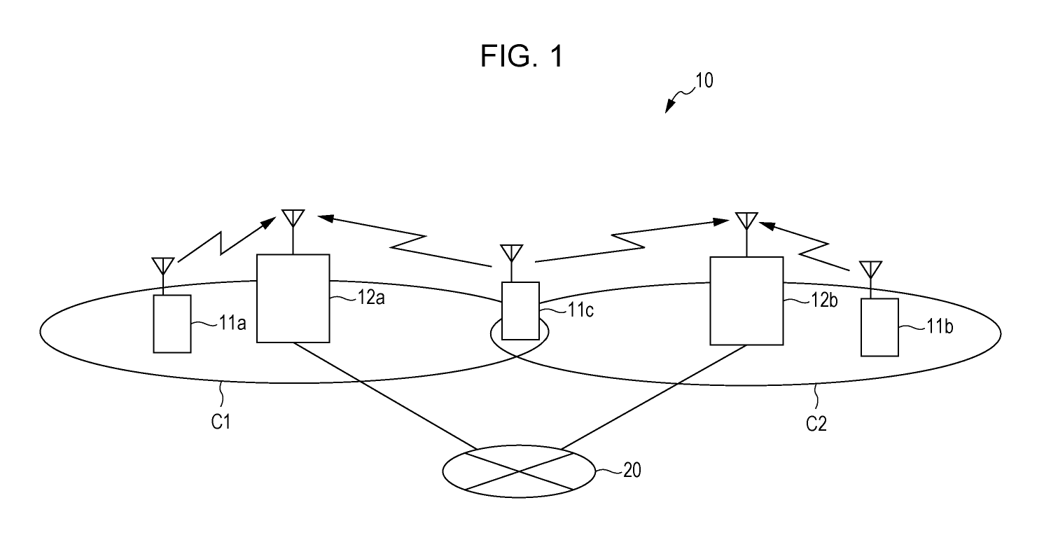

A first embodiment of the present invention will be described below with reference to the drawings. It is to be noted that an RB (Resource Block), which is defined by a predetermined number of sub-carriers, is used as an assignment unit for the number of assigned resources in the following description of embodiments, but an assignment unit different from RB may also be used. FIG. 1 is a schematic view illustrating a configuration of a wireless communication system 10 according to the first embodiment. As illustrated in FIG. 1, the wireless communication system 10 includes three mobile station devices 11a, 11b and 11c, two base station devices 12a and 12b, and a core network 20. In FIG. 1, a reference sign C1 denotes a cell representing a communication range of the base station device 12a, and a reference sign C2 denotes a cell covered by the base station device 12b. In FIG. 1, because the mobile station device 11a is positioned within the cell C1, the mobile station device 11a communicates with the base station device 12a. Furthermore, because the mobile station device 11b is positioned within the cell C2, the mobile station device 11b communicates with the base station device 12b. Because the mobile station device 11c is positioned in a region where the cell C1 and the cell C2 are overlapped with each other, the mobile station device 11b communicates with the base station devices 12a and 12b through coordinated communication. In addition, the base station device 12a and the base station device 12b communicate information for the coordinated communication with each other via the core network 20. Hereinafter, the base station device 12a, the base station device 12b, the mobile station device 12a, the mobile station device 12b, and the mobile station device 12c are also called respectively eNB1, eNB2, UE1, UE2, and UE3 in some cases.

In this embodiment, the frequency band assignment is determined such that parts of a transmission band used in the uplink by the mobile station device 11c performing the coordinated communication, the parts overlapping with respective transmission bands of the other mobile station devices 11a and 11b, are different per cell (or sector). Restoration of signals in the base station device 12a or the base station device 12b is carried out by employing a spectrum in a not-overlapped band received by one of the base station devices 12a and 12b, which perform the coordinated communication.

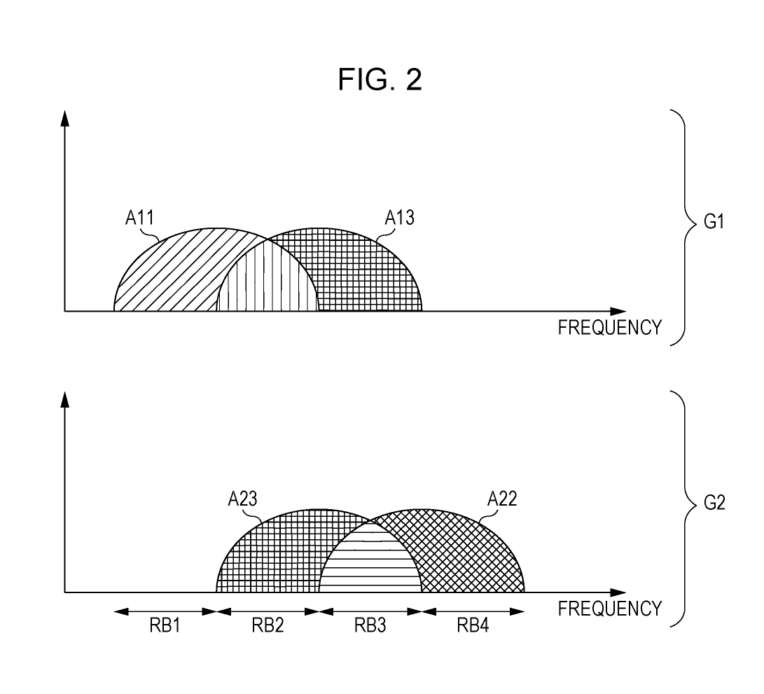

FIG. 2 is a conceptual view illustrating an example of frequency band assignment in the first embodiment. In FIG. 2, assignable RBs are 4RB, i.e., RB1 to RB4. Assignment G1 represents the assignment in eNB1, and a spectrum A11 represents that RB1 and RB2 are assigned to UE1. Similarly, a spectrum A13 represents that RB2 and RB3 are assigned to UE3. Assignment G2 represents the assignment in eNB2, and a spectrum A23 represents that RB2 and RB3 are assigned to UE3. Similarly, a spectrum A22 represents that RB3 and RB4 are assigned to UE2.

In FIG. 2, as mentioned above, RB1 and RB2 are assigned to UE1 in eNB1, and RB3 and RB4 are assigned to UE2 in eNB2. Thus, different frequency bands are assigned to UE1 and UE2. In that case, as described above, there are no frequency bands where UE3 can perform the coordinated communication in accordance with the related-art FDMA. To cope with such a situation, in this embodiment, frequency bands are assigned to UE3 performing the coordinated communication such that the assigned frequency bands overlap with respective parts of the frequency bands of UE1 and UE2. Stated in another way, the coordinated communication is performed by assigning RB2 and RB3 to UE3 in each of eNB1 and eNB2. With that assignment, in eNB1, signals of UE1 and UE3 are received in RB2 in overlapped relation. In eNB2, signals of UE2 and UE3 are received in RB3 in overlapped relation. When a reception process is executed in accordance with the related art, the overlapped frequency bands exhibit IUI (Inter-User Interference) and cause degradation of performance. In contrast, this embodiment executes spectrum separation through the coordinated communication.

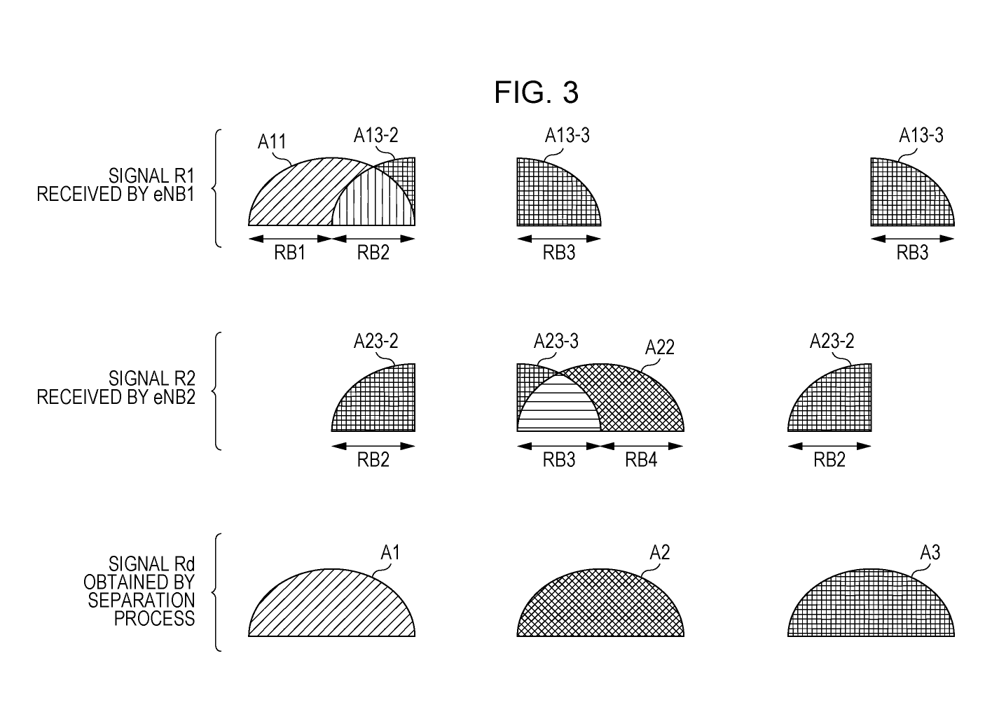

FIG. 3 illustrates a manner of separating spectra of individual mobile stations in the base station device. In FIG. 3, a first column counting from top represents a signal R1 received by eNB1, a second column represents a signal R2 received by eNB2, and a third column represents a signal Rd obtained by a separation process. In the signal R1 received by eNB1, the spectrum A11 of UE1 is overlapped in RB2 with a spectrum A13-2 of UE3. In the signal R2 received by eNB2, however, a spectrum A23-2 of UE3 is not overlapped in RB2 with the spectrum of any mobile station device (or it is overlapped with only a spectrum of the mobile station device in another cell where interference is at a sufficiently low level). Therefore, only a spectrum A1 of UE1 can be extracted by executing a process of subtracting the spectrum A23-2 of UE3 from the signal R1 received by eNB1.

Similarly, in the signal R2 received by eNB2, the spectrum A22 of UE2 is overlapped in RB3 with a spectrum A23-3 of UE3. However, only a spectrum A2 of UE2 can be extracted by executing a process of subtracting a spectrum A13-3 of UE3, which is received by eNB1. On the other hand, the spectrum of UE3 can be obtained as a spectrum A3, which includes no IUI with the other mobile stations, by extracting the spectrum A13-3 in RB3 from the signal R1 received by eNB1 and the spectrum A23-2 in RB2 from the signal R2 received by eNB2, and then combining the extracted spectra with each other.

In the example of FIG. 3, the spectrum of UE3 performing the coordinated communication is assigned such that the spectrum of UE3 in each RB is overlapped with the spectrum of the other mobile station device in any one of eNB1 and eNB2. In this embodiment, however, all the bands used by UE3 are not necessarily required to be overlapped with the bands of the other mobile stations. Furthermore, when parts of the spectrum of UE3 are each assigned to the frequency band, which is not overlapped with the frequency bands assigned to the other mobile stations in a plurality of base stations, the diversity effect can be obtained by combining spectra that are obtained in the plural base stations and that are free from IUI.

Because the mobile station devices 11a to 11c have the same configuration, they are collectively denoted as the mobile station device 11 in the following description of the device configuration. Similarly, because the base station devices 12a and 12b have the same configuration, they are collectively denoted as the base station device 12 in the following description of the device configuration. It is to be noted that the mobile station device 11 is a device including a transmission device in this embodiment, and the base station device 12 is a reception device in this embodiment. For example, a relay station may include the reception device or the transmission device insofar as a similar device configuration can be realized.

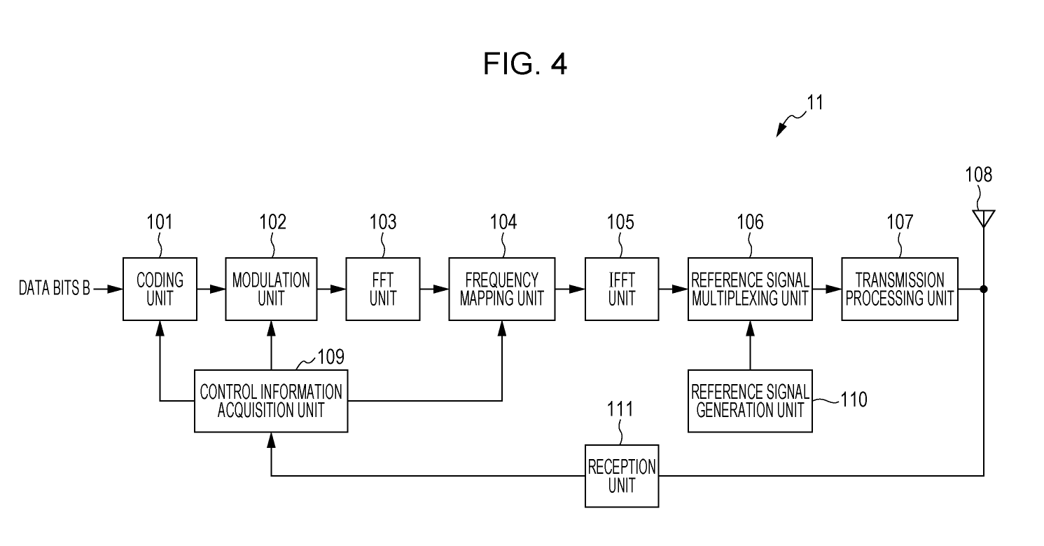

FIG. 4 is a schematic block diagram illustrating the configuration of the mobile station device 11 according to this embodiment. It is to be noted that the block diagram illustrates the configuration least necessary to explain this embodiment. The mobile station device 11 includes a coding unit 101, a modulation unit 102, an FFT (Fast Fourier Transform) unit 103, a frequency mapping unit 104, an IFFT (Inverse Fast Fourier Transform) unit 105, a reference signal multiplexing unit 106, a transmission processing unit 107, an antenna 108, a control information acquisition unit 109, a reference signal generation unit 110, and a reception unit 111. While the number of antennas in the base station device 12 is one in this embodiment, transmit diversity transmission or MIMO (Multiple Input Multiple Output) transmission may be performed by employing a plurality of antennas in transmission and reception. Here, the number of antennas is not limited to the number of physical antennas, and it may be the number of antenna ports. The antenna port is defined such that, when plural antennas can be regarded to be physically same, the number of antenna port is 1.

The reception unit 111 receives a signal from the base station device 12 via the antenna 108. The control information acquisition unit 109 obtains, from the signal received by the reception unit 111, control information notified to the relevant mobile station device 11. The control information containing information used for data transmission, such as related to frequency assignment information, a modulation multi-value order, a coding rate, etc. When the coordinated communication is performed, the control information acquisition unit 109 may obtain the control information transmitted from only a particular base station device 12, or may obtain the same control information transmitted from a plurality of base station devices 12 in a coordinated manner.

The control information acquisition unit 109 inputs information of the coding rate, which is contained in the received control information, to the coding unit 101, inputs information of the modulation multi-level order to the modulation unit 102, and inputs the frequency assignment information to the frequency mapping unit 104.

The coding unit 101 executes coding of input data bits B by employing error correcting code, such as turbo code or LDPC (Low Density Parity Check) code. An error correction coding method executed in the coding unit 101 may be determined between the transmission and reception sides in advance, or may be notified as the control information. Furthermore, the coding unit 101 executes puncturing based on the information of the coding rate, which has been notified as the control information, and then outputs generated coded bits to the modulation unit 102.

The modulation unit 102 executes, on the coded bits, one of modulations, such as QPSK (Quaternary Phase Shift Keying), 16QAM (16-ary Quadrature Amplitude Modulation), and 64QAM, the one corresponding to the modulation multi-level value that has been input from the control information acquisition unit 109. The FFT unit 103 transforms modulated symbols, which have been output from the modulation unit 102, from a data signal in the time domain to that in the frequency domain through Fast Fourier Transform (FFT), and then outputs the data signal in the frequency domain to the frequency mapping unit 104.

The frequency mapping unit 104 executes assignment of a signal (subcarrier) on the input data signal in the frequency domain in accordance with the frequency assignment information notified from the control information acquisition unit 109. The IFFT unit 105 transforms the signal, which has been output from the frequency mapping unit 104, to a time domain signal through IFFT (Inverse FFT).

The reference signal generation unit 110 generates a reference signal in accordance with a predetermined rule. The reference signal is known to both the transmission and reception sides, and is orthogonal between the mobile station devices 12. The reference signal multiplexing unit 106 executes a process of multiplexing the reference signal, which has been generated by the reference signal generation unit 110, with a transmit signal in the time domain, and then constituting a transmit frame. While the reference signal is multiplexed in the time domain in this embodiment, the reference signal may be multiplexed in the frequency domain. In addition, the reference signal may be multiplexed on the data signal, which has been mapped in the frequency mapping unit 104, in the time domain or the frequency domain.

The transmission processing unit 107 inserts a CP (Cyclic Prefix) into the signal that has been multiplexed with the reference signal. The transmission processing unit 107 converts the signal, into which the CP has been inserted, to an analog signal through D/A (Digital to Analog) conversion, and then up-converts the analog signal to wireless frequency. After amplifying the up-converted signal by a PA (Power Amplifier), the transmission processing unit 107 transmits the amplified signal from the antenna 108.

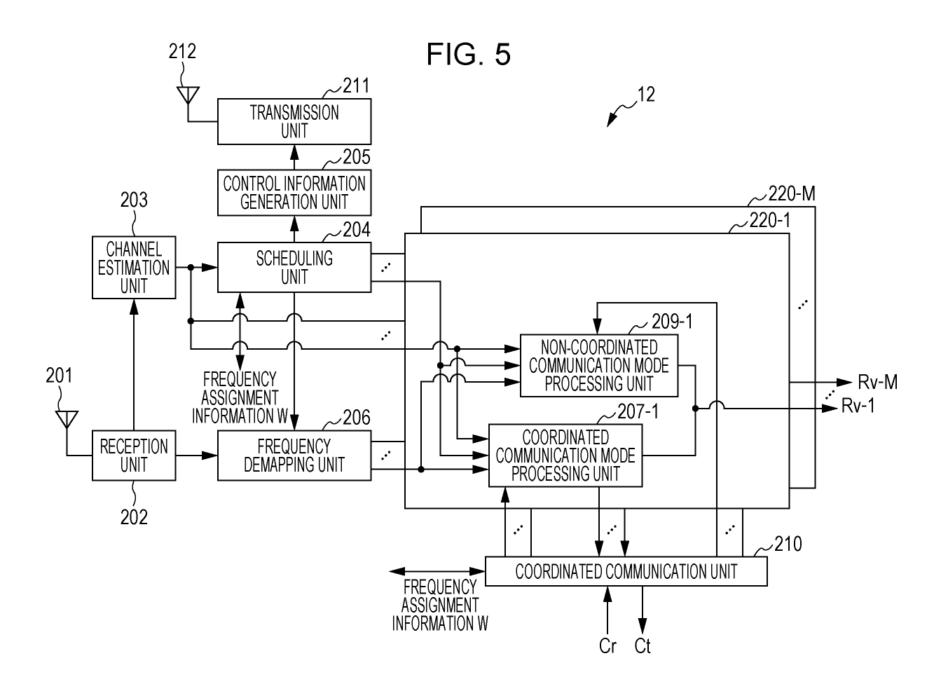

FIG. 5 is a schematic block diagram illustrating a configuration of the base station device 12 according to this embodiment. Here, the base station device 12a and the base station device 12b coordinate to perform the coordinated communication with the mobile station device 11c. In other words, the base station device 12a and the base station device 12b receive a signal transmitted from the mobile station device 11c through the coordinated communication. Because the base station device 12a and the base station device 12b have the same configuration, the configuration of the base station device 12 is described as a representative of both the base station devices. In the case of performing the coordinated communication, the number of base station devices 12 coordinating with a certain base station device 12 is not limited to one, and the certain base station device 12 may coordinate with a plurality of base station devices 12. Furthermore, while the number of receive antennas is one in this embodiment, the base station device 12 may have a plurality of receive antennas. The following description is made in connection with the case where there are, as the mobile station devices 11 connected to the base station device 12 for communication, the mobile station device 11c performing the coordinated communication and the mobile station device 11a not performing the coordinated communication.

The base station device 12 includes a receive antenna 201, a reception unit 202, a channel estimation unit 203, a scheduling unit 204, a control information generation unit 205, a frequency demapping unit 206, a plurality of reception processing units 220-1 to 220-M each per mobile station, a coordinated communication unit 210, a transmission unit 211, and a transmit antenna 212. Each of the reception processing units 220-1 to 220-M each per mobile station includes a non-coordinated communication mode processing unit 209 and a coordinated communication mode processing unit 207. Regarding the non-coordinated communication mode processing unit 209 and the coordinated communication mode processing unit 207, which one of the reception processing units 220 each per mobile station includes the relevant processing unit is clarified by allocating the same suffix number as that of the reception processing unit per mobile station, which includes the relevant processing unit, such that the non-coordinated communication mode processing unit of the reception processing unit 220-1 per mobile station is denoted as 209-1 by attaching the same suffix number as that of the reception processing unit 220-1 per mobile station to a reference sign 209, and that the non-coordinated communication mode processing unit of the reception processing unit 220-2 per mobile station is denoted as 209-2 by attaching the same suffix number as that of the reception processing unit 220-2 per mobile station to the reference sign 209.

The reception unit 202 receives a signal from the mobile station device 11 through the receive antenna 201.

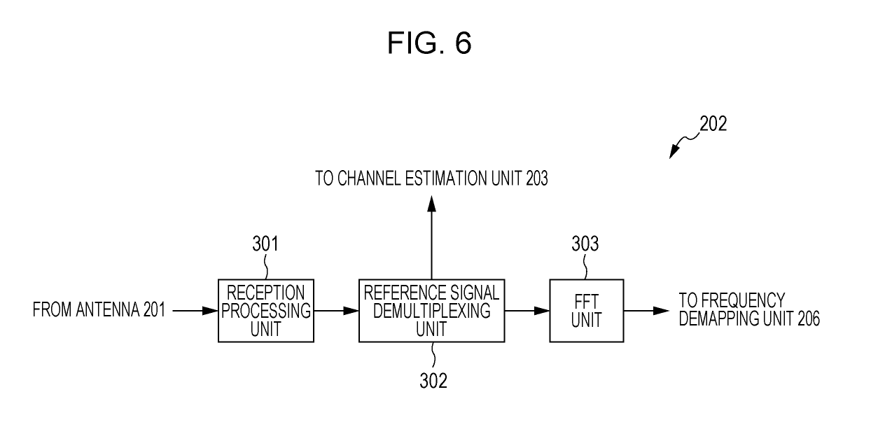

FIG. 6 is a schematic block diagram illustrating a configuration of the reception unit 202. The reception unit 202 includes a reception processing unit 301, a reference signal demultiplexing unit 302, and an FFT unit 303. The reception processing unit 301 down-converts the signal, which has been input from the receive antenna 201, to a base band frequency, converts the resulting signal to a digital signal through A/D conversion, and further outputs the digital signal to the reference signal demultiplexing unit 302 after removing the CP from the digital signal. The reference signal demultiplexing unit 302 demultiplexes the signal, input from the reception processing unit 301, into the reference signal and the data signal, the reference signal being output to the channel estimation unit 203, the data signal being output to the FFT unit 303. The FFT unit 303 transforms the demultiplexed data signal from a time domain signals to a frequency domain signal through FFT, and outputs the frequency domain signal to the frequency demapping unit 206.

Returning to FIG. 5, the channel estimation unit 203 estimates a channel characteristic (frequency response) based on the reference signal input from the reception unit 202, and outputs the estimated channel characteristic to the scheduling unit 204, the coordinated communication mode processing units 207-1 to -M, and to the non-coordinated communication mode processing units 209-1 to -M. Here, M represents the number of the mobile station devices 11 for which the reception process can be executed at the same time. In other words, this implies that the relevant base station device 12 can simultaneously execute the reception processes of signals transmitted from a number M of mobile station devices 11. Furthermore, the reference signs X-1 to -M imply that processes in blocks denoted by the sign X are executed in parallel for the transmit signals that are to be restored. However, those blocks may be constituted by the same circuit.

The scheduling unit 204 has the function of sharing frequency assignment information W with the other base station device 12 via the coordinated communication unit 210. The scheduling unit 204 obtains the channel characteristic information estimated by the channel estimation unit 203 and the frequency assignment information W of the other base station device 12, which is input from the coordinated communication unit 210. The obtained frequency assignment information W contains at least information indicating a part of a band assigned to the mobile station device 11 with which the other base station device 12 and the relevant base station device 12 communicate in a coordinated manner, the part overlapping in the other base station device 12 with a band assigned to another mobile station device 11. Furthermore, the scheduling unit 204 notifies the frequency assignment information W of the relevant base station device 12 to the scheduling unit 204 of the other base station device 12 via the coordinated communication unit 210. The notified frequency assignment information W contains at least information indicating a part of a band assigned to the mobile station device 11 with which communication is performed in a coordinated manner, the part overlapping in the relevant base station device 12 with a band assigned to the other mobile station device 11.

The scheduling unit 204 determines, based on the obtained information described above, parameters necessary for data transmission, such as an assignment band used for the transmission by each mobile station device 11 connected to the relevant base station device 12, a coding rate, and a modulation method, and then inputs those parameters to the control information generation unit 205. Details of a method for determining the assignment band will be described later. The determined parameters are held until receiving next data because those parameters are needed to execute processing of the next received signal. Of the held parameters, the frequency assignment information containing not only the information indicating which one of the mobile station devices 11 communicates with the relevant base station device 12 in a coordinated manner, but also the information indicating the band assigned to each of the mobile station devices communicating with the relevant base station device 12 is further input to the frequency demapping unit 206, the coordinated communication mode processing units 207-1 to -M, and to the non-coordinated communication mode processing units 209-1 to -M.

The control information generation unit 205 generates control information for the next transmission opportunity from the parameters that have been determined by the scheduling unit 204. The transmission unit 211 transmits the control information, which has been generated by the control information generation unit 205, via the transmit antenna 212, thus notifying the control information to each mobile station device 11. The function of the transmit antenna 212 may be executed by the receive antenna 201, and an output of the transmission unit 211 may be notified to each mobile station device 11 from the receive antenna 201.

In accordance with the frequency assignment information input from the scheduling unit 204, the frequency demapping unit 206 extracts, from the frequency domain signal output from the reception unit 202 (specifically, the FFT unit 303), a signal (spectrum) in the band assigned to each mobile station device 11. The band assigned to each mobile station device 11 may be contiguous or discrete. Subsequent processes are executed in parallel per extracted signal in order to restore the signal from each mobile station device 11.

The frequency demapping unit 206 outputs the extracted signal (spectrum) in the band assigned for each mobile station device 11 to one of the reception processing units 220-1 to 220-M each per mobile station. For example, the frequency demapping unit 206 of the base station device 12a outputs the signal in the band assigned to the mobile station device 11a to the reception processing unit 220-1 per mobile station, and outputs the signal in the band assigned to the mobile station device 11c to the reception processing unit 220-2 per mobile station.

In the case of outputting the signal as described above, the frequency demapping unit 206 determines whether each mobile station device 11 performs the coordinated communication, and outputs, to one of the coordinated communication mode processing units 207-1 to -M, the signal extracted from the band assigned to the mobile station device 11 that performs the coordinated communication. Furthermore, the frequency demapping unit 206 outputs, to one of the non-coordinated communication mode processing units 209-1 to -M, the signal extracted from the band assigned to the mobile station device 11 that does not perform the coordinated communication. Each of the coordinated communication mode processing units 207-1 to -M deletes a signal in an overlapped band from the signal input from the frequency demapping unit 206, and then executes an equalization process. Moreover, each of the coordinated communication mode processing units 207-1 to -M combines the signal after the equalization process and a signal obtained from the coordinated communication unit 210, and then executes a demodulation process and a decoding process. Each of the non-coordinated communication mode processing units 209-1 to -M cancels an overlapped signal from the signal input from the frequency demapping unit 206, and then executes an equalization and demodulation process.

Processing after the demapping will be described below in connection with, for example, the case where the mobile station device 11c performs the coordinated communication, the mobile station device 11a does not perform the coordinated communication, and a part of the band assigned to the mobile station device 11c is overlapped with a part of the band assigned to the mobile station device 11a.

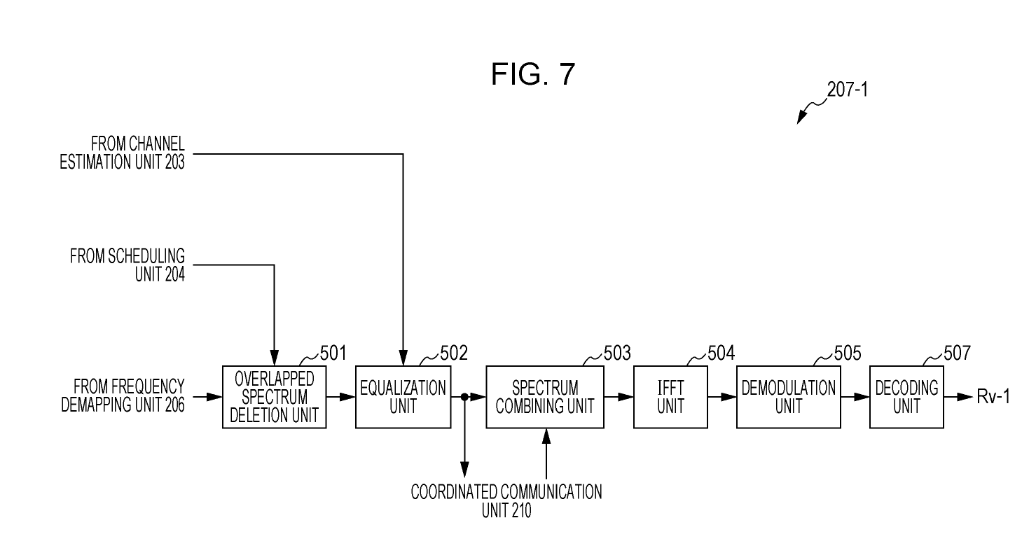

FIG. 7 is a schematic block diagram illustrating a configuration of the coordinated communication mode processing unit 207-1 according to this embodiment. It is to be noted that, because the coordinated communication mode processing units 207-2 to 207-M also have the same configuration as that of the coordinated communication mode processing unit 207-1 as described above, description of the coordinated communication mode processing units 207-2 to 207-M is omitted.

The coordinated communication mode processing unit 207-1 includes an overlapped spectrum deletion unit 501, an equalization unit 502, a spectrum combining unit 503, an IFFT unit 504, a demodulation unit 505, and a decoding unit 507. The following description of FIG. 7 is made on an assumption that the reception processing unit 220-1 per mobile station restores the signal transmitted from the mobile station device 11c performing the coordinated communication, i.e., that the coordinated communication mode processing unit 207-1 restores the signal transmitted from the mobile station device 11c.

The overlapped spectrum deletion unit 501 deletes a part of a spectrum that is input from the frequency demapping unit 206 and that corresponds to a transmission band (assignment band) assigned to the mobile station device 11 (e.g., the mobile station device 11c) performing the coordinated communication, the part being overlapped with a band assigned to another mobile station device 11 (e.g., the mobile station device 11a). The overlapped spectrum deletion unit 501 determines, based on the frequency assignment information input from the scheduling unit 204, which band (RB) is overlapped. Such a deletion process corresponds to, in FIG. 3, the process of generating the spectrum A13-3 in eNB1 by deleting the spectrum in RB2 from the received signals in RB2 and RB3 that are assigned to UE3, and the process of generating the spectrum A23-2 in eNB2 by deleting the spectrum in RB3 therefrom. The overlapped spectrum deletion unit 501 inputs the spectrum after the deletion process to the equalization unit 502.

The equalization unit 502 executes, on the spectrum after the deletion process, an equalization process of compensating for distortion, which has been caused by the wireless channel, by employing the channel characteristic input from the channel estimation unit 203. The equalization unit 502 outputs the spectrum (partial spectrum) after the equalization process to the spectrum combining unit 503 and the coordinated communication unit 210. The channel characteristic used in the above-described equalization process is the channel characteristic of the wireless channel between the mobile station device 11 (here, the mobile station device 11c) performing the coordinated communication and the relevant base station device 12. The equalization process implies a process of multiplying an MMSE (Minimum Mean Square Error) weight or a ZF (Zero Forcing) weight, which is determined from the channel characteristic.

The spectrum combining unit 503 combines the partial spectrum input from the equalization unit 502 and a partial spectrum input, through the coordinated communication unit 210, from the other base station device 12 coordinating with the relevant base station device 12. The restoration of the signal from the mobile station device 11 (mobile station device 11c) performing the coordinated communication is just required to be executed in one of the relevant base station device 12 and the other base station device 12. In the other mobile station device 11 not performing the restoration, therefore, the processing may be ended without executing the above-mentioned combining.

Subsequent processing will be described below on an assumption that the signal restoration is executed in the relevant base station device 12. In this embodiment, the overlapped band is different between the relevant base station device 12 and the other base station device 12. Thus, the partial spectrum input from the other base station device 12 includes the spectrum corresponding to the band that has been deleted by the overlapped spectrum deletion unit 501. Accordingly, the spectrum combining unit 503 can obtain the spectrum in all the bands including the deleted band, which have been used in the transmission, by combining the partial spectrum input from the other base station device 12 and the partial spectrum input from the equalization unit 502 with each other.

For the band that has not been deleted by both the relevant base station device 12 and the other base station device 12, the spectrum combining unit 503 averages the partial spectrum input from the relevant base station device 12 (i.e., from the equalization unit 502) and the partial spectrum input from the other base station device 12 (i.e., from the coordinated communication unit 210). An averaging method can be practiced, for example, by a method of simply averaging the spectra received by the relevant base station device 12 and the other base station device 12, or a method of calculating a weighted average of those two spectra by employing the channel characteristic. One of the two spectra may be selected instead of averaging them. The spectrum combining unit 503 outputs the spectrum (frequency domain signal), which has been obtained by the above-described combining or averaging, to the IFFT unit 504.

The IFFT unit 504 transforms the signal, which has been output from the spectrum combining unit 503, from a frequency domain signal to a time domain signal through IFFT, and then outputs the time domain signal to the demodulation unit 505. The demodulation unit 505 executes a symbol demodulation process on the signal output from the IFFT unit 504 in accordance with the information of the modulation multi-level order that is held in the scheduling unit 204, and then outputs a resulting LLR (Log Likelihood Ratio) to the decoding unit 507. The information of the coding rate of the error correction code, which has been used in the transmission and which is held in the scheduling unit 204, is input to the decoding unit 507. In accordance with that input information, the decoding unit 507 executes error correction decoding on the LLR output from the demodulation unit 505, and then outputs, as received data Rv-1, a bit sequence resulting from the decoding.

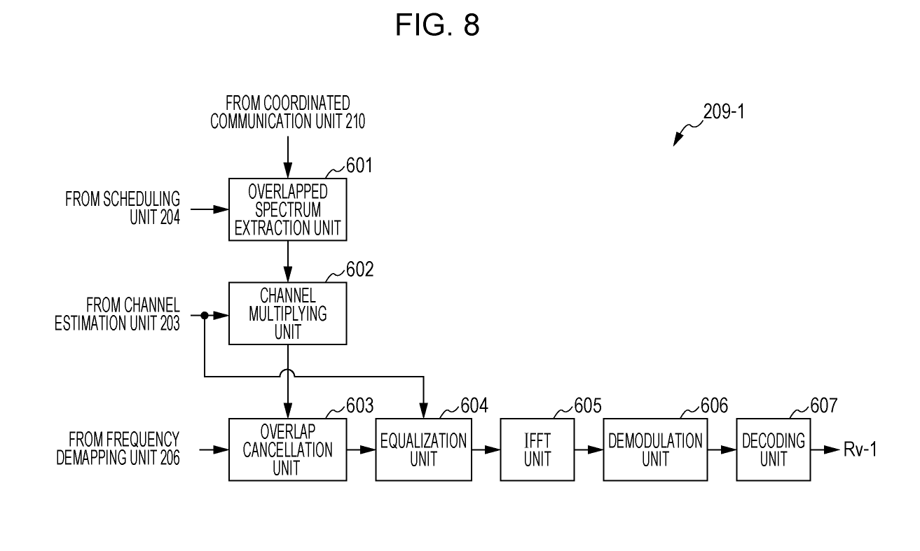

FIG. 8 is a schematic block diagram illustrating a configuration of the non-coordinated communication mode processing unit 209-1 according to this embodiment. Because the non-coordinated communication mode processing units 209-2 to 209-M also have the same configuration as that of the non-coordinated communication mode processing unit 209-1 as described above, description of the non-coordinated communication mode processing units 209-2 to 209-M is omitted. The non-coordinated communication mode processing unit 209-1 includes overlapped spectrum extraction unit 601, a channel multiplying unit 602, an overlap cancellation unit 603, an equalization unit 604, an IFFT unit 605, a demodulation unit 606, and a decoding unit 607.

The following description of FIG. 8 is made on an assumption that the reception processing unit 220-1 per mobile station restores the signal transmitted from the mobile station device 11a not performing the coordinated communication, i.e., that the non-coordinated communication mode processing unit 209-1 restores the signal transmitted from the mobile station device 11a.

The overlapped spectrum extraction unit 601 obtains, from the coordinated communication unit 210, a partial spectrum of the mobile station device 11 (here, the mobile station device 11c) performing the coordinated communication. That partial spectrum is obtained as follows. The equalization unit 502 of the other coordinating base station device 12 outputs the partial spectrum, which is transmitted to the relevant base station device 12 from the coordinated communication unit 210 of the other base station device 12. Then, the output partial spectrum is received by the coordinated communication unit 210 of the relevant base station device 12. Furthermore, the overlapped spectrum extraction unit 601 determines, based on the frequency assignment information input from the scheduling unit 204, a band portion where the band assigned to the mobile station device 11 (mobile station device 11a) as a processing target and the band assigned to the mobile station device 11 (mobile station device 11c) performing the coordinated communication are overlapped with each other. Then, the overlapped spectrum extraction unit 601 extracts the overlapped band portion from the partial spectrum, which has been obtained from the coordinated communication unit 210, and outputs the extracted band portion to the channel multiplying unit 602.

The channel multiplying unit 602 obtains, from the channel estimation unit 203, the channel characteristic of the mobile station device 11 (mobile station device 11c) performing the coordinated communication. The channel multiplying unit 602 multiplies the spectrum, which has been output from the overlapped spectrum extraction unit 601, by the obtained channel characteristic. The multiplying process generates a replica of the received signal from the mobile station device 11 (mobile station device 11c), which is overlapped with the mobile station device 11 (mobile station device 11a) as the processing target. The channel multiplying unit 602 outputs the generated replica to the overlap cancellation unit 603.

The overlap cancellation unit 603 subtracts the replica, which has been output from the channel multiplying unit 602, from the signal (spectrum) input from the frequency demapping unit 206, and then outputs the subtraction result. With the subtraction, the replica of the overlapped signal from the mobile station device 11 (mobile station device 11c), i.e., the replica of an interference signal interfering with the signal from the mobile station device 11 (mobile station device 11a) as the processing target, is removed from the received signal.

The equalization unit 604 executes, on the signal output from the overlap cancellation unit 603, an equalization process by employing the channel characteristic output from the channel estimation unit 203. The IFFT unit 605 executes IFFT on the signal obtained with the equalization process for transform from frequency domain signals to time domain signals. The demodulation unit 606 executes a demodulation process on the time domain signal, thereby generating an LLR. The decoding unit 607 executes error correction decoding on the LLR generated by the demodulation unit 606. The decoding unit 607 then outputs a bit sequence resulting from the decoding as received data Rv-1 from the mobile station device 11 (mobile station device 11a) as the processing target. It is to be noted that, since the functions of the equalization unit 604, the IFFT unit 605, the demodulation unit 606, and the decoding unit 607 are respectively the same as those of the equalization unit 502, the IFFT unit 504, the demodulation unit 505, and the decoding unit 507 illustrated in FIG. 7, they may be each configured as the same circuit as that illustrated in FIG. 7.

The coordinated communication unit 210 is connected to the coordinated communication unit 210 of the other base station device 12 via wired communication, for example, and it exchanges the information obtained through the reception process in the relevant base station device 12 with the information obtained through the reception process in the other base station device 12. The following description is made, as an example, in connection with the case where the signal from the mobile station device 11c is processed by the respective coordinated communication mode processing units 207-1 of the base station device 12a and the base station device 12b, and the signal from the mobile station device 11a is processed by the non-coordinated communication mode processing unit 209-2 of the base station device 12a. The coordinated communication unit 210 of the base station device 12a obtains the partial spectrum output from the equalization unit 502 in the coordinated communication mode processing unit 207-1 of the base station device 12a, and transfers information Ct representing the obtained partial spectrum to the coordinated communication unit 210 of the base station device 12b. Furthermore, the coordinated communication unit 210 of the base station device 12a outputs the partial spectrum, which is represented by information Cr notified from the coordinated communication unit 210 of the base station device 12b, to the spectrum combining unit 503 of the coordinated communication mode processing unit 207-1 and to the overlapped spectrum extraction unit 601 of the non-coordinated communication mode processing unit 209-2. However, when the restoration of the signal from the mobile station device 11c is executed only in the base station device 12b, the outputting of the partial spectrum to the spectrum combining unit 503 is not required in the base station device 12a.

The partial spectrum output from each equalization unit 502 is the partial spectrum obtained after the relevant base station device 12 has executed the equalization process on the partial spectrum resulting from deleting a portion of the assignment band in the overlapped spectrum deletion unit 501, which portion is overlapped with the assignment band assigned to the other mobile station device 11. Accordingly, the partial spectrum represented by the information Ct transmitted from the coordinated communication unit 210 of the base station device 12a is a spectrum in a band of the spectrum of the mobile station device 11 performing the coordinated communication, the band being not overlapped with the band assigned to the other mobile station device 11 in the base station device 12a. Moreover, the partial spectrum represented by the information Cr received by the coordinated communication unit 210 of the base station device 12a is a spectrum in a band of the spectrum of the mobile station device 11 performing the coordinated communication, the band being not overlapped with the band assigned to the other mobile station device 11 in the base station device 12b.

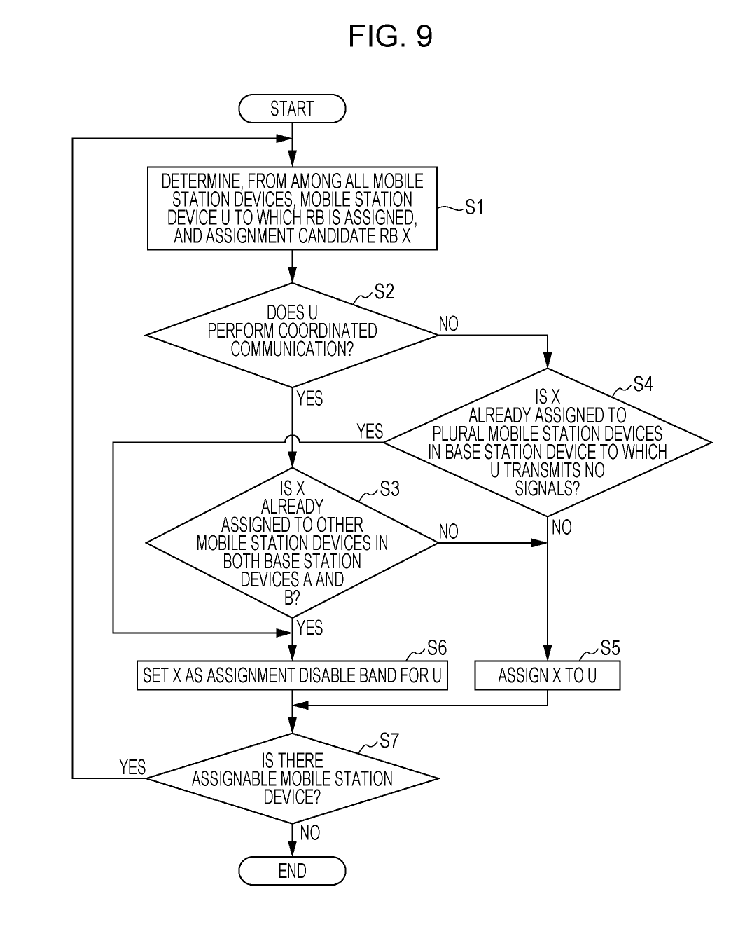

FIG. 9 is a flowchart to explain a frequency assignment process in the scheduling unit 204. Upon start of the frequency assignment process (also called scheduling), the scheduling unit 204 first determines in step S1, from among all the mobile station devices 11 transmitting data to any of base station devices A and B performing the coordinated communication (hereinafter referred to simply as “all the mobile station devices”), a mobile station device U to which RB for an uplink is assigned, and an assignment candidate RB X for U. Then, the scheduling unit 204 shifts to step S2. The determination in step S1 can be practiced, for example, by an assignment method such as Proportional Fairness (PF), Maximum Carrier to Interference Ratio (Max CIR), or Round Robin (RR). Priority (order in assignment) between the base station devices A and B may be set such that higher priority is alternately given to the base station devices A and B, i.e., such that a mobile station device with highest priority in the base station device B follows a mobile station device with highest priority in the base station device A, a mobile station device with second highest priority in the base station device A follows, and a mobile station device with second highest priority in the base station device B further follows. As an alternative, priority may be determined among all the base station devices regardless of different base station devices in a similar manner to the case of determining priority in one base station device.

In step S2, the scheduling unit 204 determines whether the mobile station device U determined in step S1 is a device performing the coordinated communication. If the determination result indicates that the mobile station device U is the device performing the coordinated communication, the scheduling unit 204 shifts to step S3. If the determination result indicates that the mobile station device U is a device not performing the coordinated communication, the scheduling unit 204 shifts to step S4. Whether the mobile station device U is the device performing the coordinated communication is determined, for example, based on not only whether the mobile station device U has a capability to perform the coordinated communication, but also whether the mobile station device U is positioned in a region where respective cells of both the base station devices A and B are overlapped with each other. In other words, when the mobile station device has the capability to perform the coordinated communication and is positioned in the overlapped region, the relevant mobile station device is determined as the device performing the coordinated communication. Otherwise, the relevant mobile station device is determined as the device not performing the coordinated communication. In addition, whether the relevant mobile station device has the capability to perform the coordinated communication is determined, for example, as follows. Information representing such capability is set to be contained in performance information of the mobile station device U, the performance information being notified from the mobile station device U to the base station device A or B, and the scheduling unit 204 makes the determination by referring to the capability information. Whether the relevant mobile station device is positioned in the overlapped region is determined, for example, by measuring a signal transmitted from the mobile station device U in the base station device A or B, and by making the determination based on power of the received signal.

In step S3, the scheduling unit 204 determines whether X, i.e., the assignment candidate RB, is already assigned to other mobile station devices in both the base station device A and the base station device B. If the determination result indicates that X is not assigned in any one of both the base station devices, the scheduling unit 204 shifts to step S5, and if the determination result indicates that X is assigned in both the base station devices, the scheduling unit 204 shifts to step S6. On the other hand, in step S4, the scheduling unit 204 determines whether X, i.e., the assignment candidate RB, is already assigned to other plural mobile station devices in any of the base station devices A and B to which the mobile station device U transmits no signals (namely, determines whether an overlap occurs). If the determination result indicates that X is already assigned to the plural mobile station devices, the scheduling unit 204 shifts to step S6, and if otherwise (namely, if X is assigned to only one mobile station device, of if X is not assigned to any mobile station device), the scheduling unit 204 shifts to step S5. In step S5, the scheduling unit 204 assigns X, i.e., the assignment candidate RB, to the mobile station device U, and then shifts step S7. On the other hand, in step S6, the scheduling unit 204 does not assign X to U, and shifts to step S7 after setting X to be regarded as an assignment disable band for U after that time. In step S7, the scheduling unit 204 determines whether, among all the mobile station devices 11, there is the mobile station device 11 to which RB can be assigned. If there is the assignable mobile station device, the scheduling unit 204 returns to step S1. If there are no assignable mobile station devices, the scheduling unit 204 brings the scheduling to an end.

With the scheduling executed by the scheduling unit 204 as described above, the RB (band) assigned to plural mobile station devices in one base station device is assigned to only one of those plural mobile station device in the other base station device. Accordingly, by executing the above-described processes on the signal transmitted in accordance with the above-described scheduling in the coordinated communication mode processing unit 207, the non-coordinated communication mode processing unit 209, and the coordinated communication unit 210, the reception process can be executed without causing significant IUI. In other words, even when transmission is performed in a state overlapped in a partial band, received data can be obtained without causing significant IUI in the reception process.

The scheduling units 204 of the base station devices 12 may exchange, via the core network 20, details of the scheduling (i.e., information representing which RB is assigned to which the mobile station device), or just information representing how many mobile station devices 11 are assigned to which RB. Anyway, it is required that at least the bands assigned to the mobile station device 11 performing the coordinated communication are exchanged between the scheduling units 204 of the base station devices 12.

Furthermore, the scheduling unit 204 of the base station device 12a may execute the scheduling for the base station device 12b as well, and may notify the scheduling result to the base station device 12b. In that case, the scheduling unit 204 of the base station device 12a obtains, from the scheduling unit 204 of the base station device 12b, information representing assignment priority of each RB, such as CQI (Channel Quality Indicator), for each mobile station device 11.

For the mobile station device 11 not performing the coordinated communication, the scheduling units 204 of the base station devices 12a and 12b may individually determine the band assignment. For the mobile station device 11 performing the coordinated communication, the scheduling unit 204 of the base station device 12a may, for example, obtain information representing a band, which is not assigned to any mobile station device 11 in the base station device 12b, from the scheduling unit 204 of the base station device 12b, and assign a band, which is not assigned to any mobile station device 11 in one of the base station devices 12, to the relevant mobile station device 11.

In the embodiment described above, the coordinated communication unit 210 transmits, to the other base station device 12, the information representing the partial spectrum output from the equalization unit 502. However, the coordinated communication unit 210 may extract, from the partial spectrum, a spectrum in an assignment band overlapping with that assigned to the other mobile station device 11 in the other base station device 12, and may transmit the extracted partial spectrum to the other base station device 12. In such a case, the coordinated communication unit 210 determines, based on the frequency assignment information of the other base station device 12, which band is overlapped with that assigned to the other mobile station device 11 in the other base station device 12. The frequency assignment information of the other base station device 12 is notified, for example, to the coordinated communication unit 210 from the scheduling unit 204 that shares the frequency assignment information with the scheduling unit 204 of the other base station device 12.

In this embodiment, as described above, when the mobile station device 11 performing the coordinated communication with two base station devices 12 is present in a cell, band assignment is executed such that a part of a transmission band assigned to the relevant mobile station device 11, the part being different per cell, is overlapped with that assigned to the other mobile station device 11. With that band assignment, it is possible to increase the band widths and the assignment candidate bands, which can be assigned by the mobile station device 11 performing the coordinated communication and the other mobile station device 11. On that occasion, degradation of performance caused by IUI can be suppressed by exchanging spectrum information, which represents the assignment causing no IUI, between the base station devices 12 through the coordinated communication units 210, and by executing the reception process in accordance with such spectrum information. As a result, a cell throughput can be improved with flexible frequency assignment.

### Second Embodiment

In the first embodiment, the transmission band of the mobile station device performing the coordinated communication with two base station devices is set to be not overlapped with (i.e., orthogonal to) the transmission band of the other mobile station device in any one base station device per assignment unit. In this respect, of signals received through the coordinated communication, a spectrum in an overlapped band (i.e., a non-orthogonal band) is not used in the decoding for the purpose of facilitating the reception process. In contrast, a second embodiment represents the case where the diversity effect with the coordinated communication is increased by applying nonlinear iterative equalization using a soft canceller to the reception process, and by utilizing information of the signal in the overlapped band.

A wireless communication system 10a according to this embodiment is similar to the wireless communication system 10 illustrated in FIG. 1 except for including the base station devices 13a and 13b instead of the base station devices 12a and 12b. Details of the base station devices 13a and 13b will be described later.

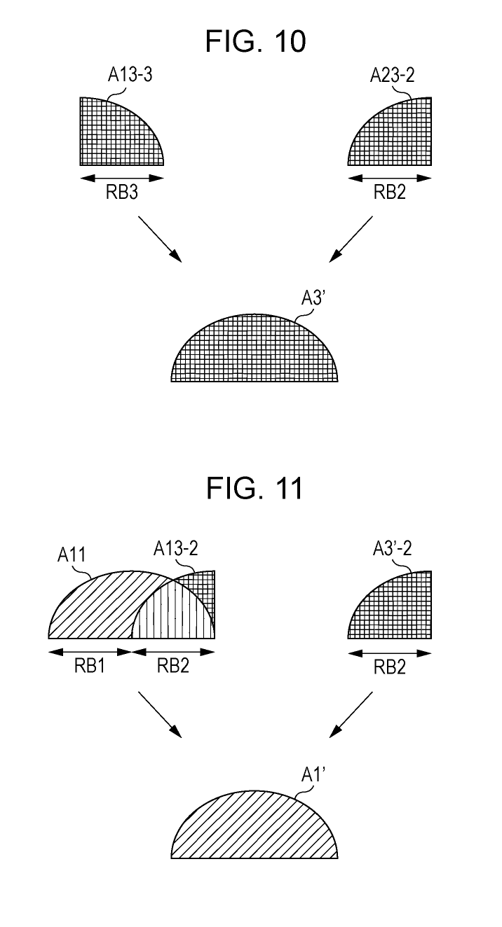

A method for separating a spectrum of each mobile station device in the second embodiment is described on an assumption that similar assignment bands to those in the first embodiment, illustrated in FIG. 2, are used. Prior to executing an iterative equalization process, a similar process to that made on the spectrum of UE3 in the first embodiment is first executed. FIG. 10 is a conceptual view to explain a first process in the iterative equalization process. In the first process, as illustrated in FIG. 10, the spectrum A13-3 of RB3 received by eNB1 and the spectrum A23-2 of RB2 received by eNB2 are combined to generate the above-mentioned spectrum A3. Furthermore, error correction is executed on the spectrum A3 to generate a transmission replica A3′ of UE3. Because the transmission replica A3′ of UE3 is generated from the received signals including no IUI, the replica free from degradation of reception quality caused by interference can be generated. In the subsequent iterative equalization process in each base station device 12, therefore, interference is removed by employing the replica generated as described above.

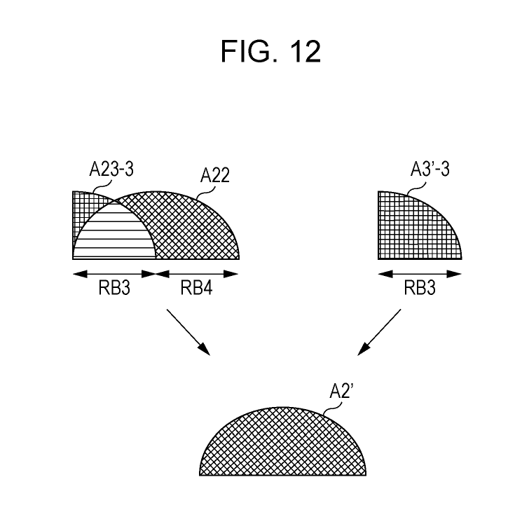

FIG. 11 is a conceptual view to explain a reception process for a spectrum of UE1. UE1 is the mobile station device 11 not performing the coordinated communication. For UE1, a restoration process and generation of a transmission replica A1′ for UE1 are executed by subtracting an interference replica, which is obtained by multiplying the spectrum A3′-2 in RB2 of the transmission replica A3′ of UE3 by a channel characteristic, from the signals A11 and A13-2 received in RB1 and RB2 by eNB1, and by executing error correction on the resulted signal. FIG. 12 is a conceptual view to explain a reception process for a spectrum of UE2. Regarding UE2, as in the case of UE1, a restoration process and generation of a transmission replica A2′ for UE2 are executed by subtracting an interference replica, which is obtained by multiplying the spectrum A3′-3 in RB3 of the transmission replica A3′ of UE3 by a channel characteristic, from the signals A23-3 and A22 received in RB3 and RB4 by eNB2, and by executing error correction on the resulted signal.

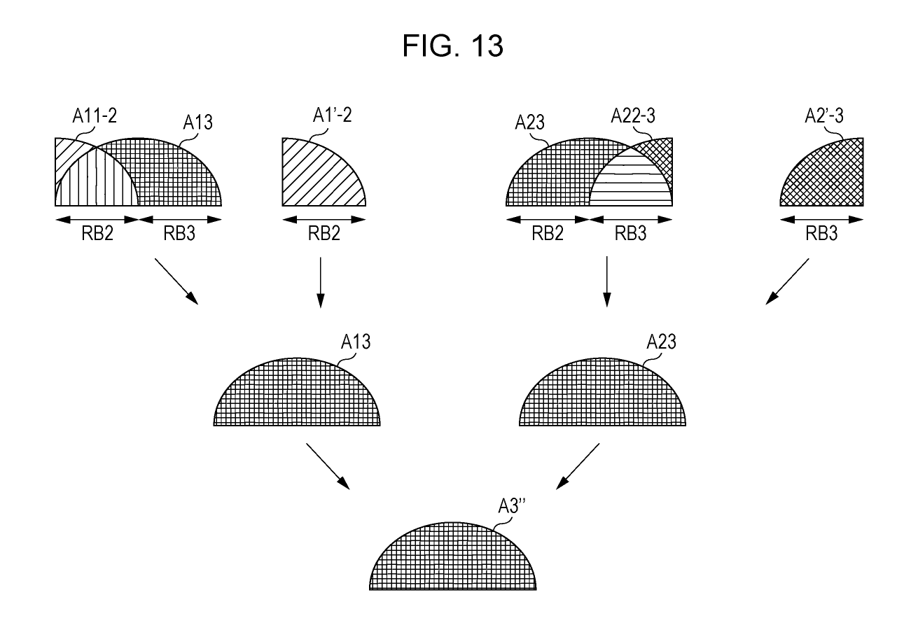

FIG. 13 is a conceptual view to explain a reception process for a spectrum of UE3. First, respective signals received by the individual base stations are extracted. In eNB1, the signal A11-2 of UE1 is overlapped with the signal A13 of UE3, which is received in RB2 and RB3. Accordingly, eNB1 extracts the spectrum A13 of UE3, which is received by eNB1, through a cancellation process using the spectrum A1′-2 in RB2 of the transmission replica A1′ of UE1, which has been generated as described above. Likewise, in eNB2, the signal A22-3 of UE2 is overlapped with the signal A23 of UE3, which is received in RB2 and RB3. Accordingly, eNB2 extracts the spectrum A23 of UE3, which is received by eNB2, through a cancellation process using the spectrum A2′-3 in RB3 of the transmission replica A2′ of UE2.

Furthermore, a restoration process and generation of a transmission replica A3″ for UE3 are executed by demodulating the spectra A13 and A23 of UE3, which have been extracted respectively by eNB1 and eNB2, combining the spectra A13 and A23 through an addition process, and by executing error correction. As a result, the transmission replica A3″ of UE3 can be generated with higher reliability than that of the transmission replica A3′ of UE3 generated as illustrated in FIG. 10. Reliability of the transmission replica for each mobile station device and the result of the restoration process can be increased by executing iterative processing in which similar processes to those illustrated in FIGS. 11 to 13 are repeated using the generated transmission replica A3″. Thus, since the spectrum in the overlapped band is easily separated, information can be obtained from the overlapped signals as well in the reception process of UE3 in which only the not-overlapped band is used in the first embodiment. As a result, the diversity effect in the coordinated communication is improved.

The mobile station device 11 in this embodiment has the same configuration as that illustrated in FIG. 4 (i.e., in the first embodiment), and description thereof is omitted here. Because the base station devices 13a and 13b in this embodiment have the same configuration, the configuration of a base station device 13 as a representative is described below.

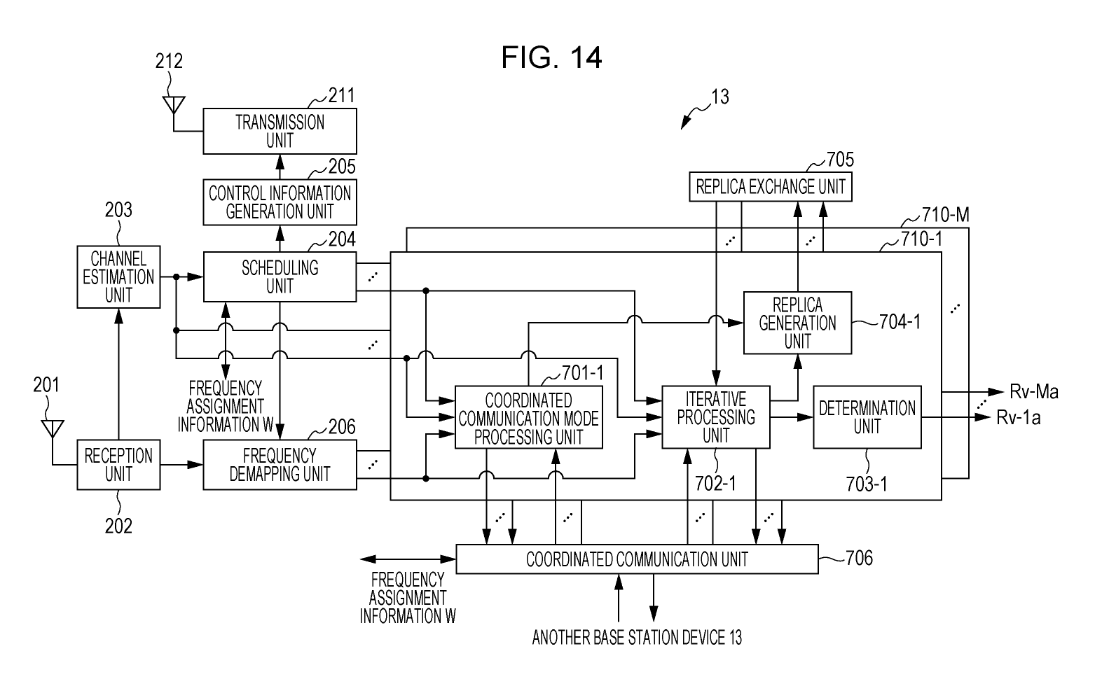

FIG. 14 is a schematic block diagram illustrating the configuration of the base station device 13 according to the second embodiment. In FIG. 14, components corresponding to those in FIG. 5 are denoted by the same reference signs (201 to 206, 211, and 212), and description of those components is omitted. The base station device 13 includes a receive antenna 201, a reception unit 202, a channel estimation unit 203, a scheduling unit 204, a control information generation unit 205, a frequency demapping unit 206, a plurality of reception processing units 710-1 to 710-M each per mobile station, a replica exchange unit 705, a coordinated communication unit 706, a transmission unit 211, and a transmit antenna 212. Each of the reception processing units 710-1 to 710-M each per mobile station includes a coordinated communication mode processing unit 701, an iterative processing unit 702, a determination unit 703, and a replica generation unit 704. Regarding the coordinated communication mode processing unit 701, the iterative processing unit 702, the determination unit 703, and the replica generation unit 704, which one of the reception processing units 710 each per mobile station includes the relevant unit is clarified as required by allocating the same suffix number as that of the reception processing unit per mobile station, which includes the relevant unit.

Signals extracted by the frequency demapping unit 206 only from the bands used by the individual mobile station devices 11 are processed in parallel per mobile station device 11. The output signals of the frequency demapping unit 206 are input to the coordinated communication mode processing units 701-1 to -M and the iterative processing units 702-1 to -M. Only when the output signals are targets of the coordinated communication, those output signals are processed in the coordinated communication mode processing unit 701-1 to -M.

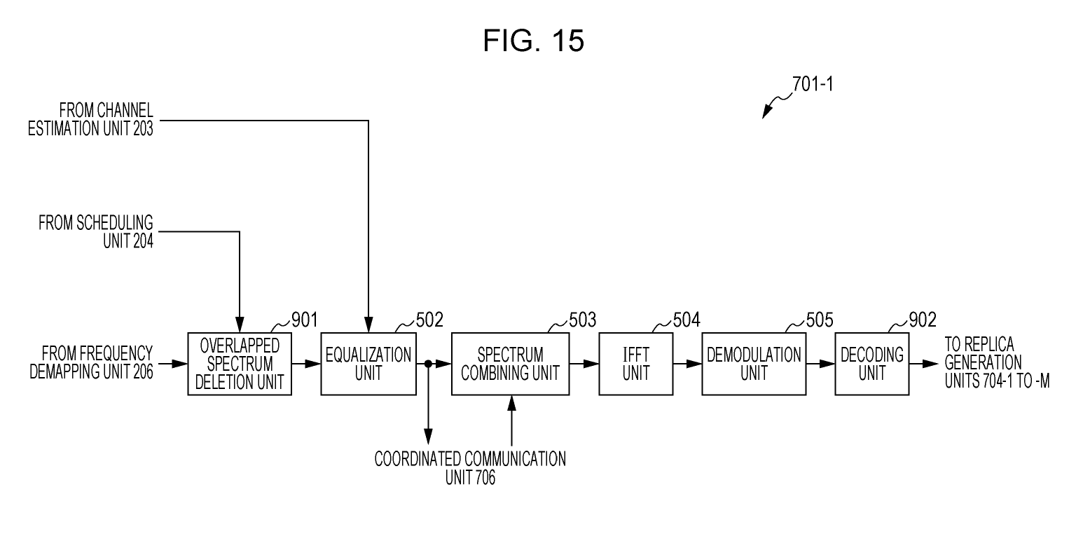

FIG. 15 is a schematic block diagram illustrating a configuration of the coordinated communication mode processing unit 701-1. It is to be noted that, because the coordinated communication mode processing units 701-2 to 701-M also have the same configuration as that of the coordinated communication mode processing unit 701-1, description of the coordinated communication mode processing units 701-2 to 701-M is omitted. In FIG. 15, components corresponding to those in FIG. 7 are denoted by the same reference signs (502 to 505), and description of those components is omitted. The coordinated communication mode processing unit 701-1 includes an overlapped spectrum deletion unit 901, an equalization unit 502, a spectrum combining unit 503, an IFFT unit 504, a demodulation unit 505, and a decoding unit 902.

The overlapped spectrum deletion unit 901 deletes, from a spectrum received from the mobile station device 11 as the processing target and output by the frequency demapping unit 206, a spectrum in a band where an overlap occurs with respect to another mobile station device 11. The overlapped spectrum deletion unit 901 determines the band where the overlap occurs, based on the frequency assignment information of each mobile station device 11 output from the scheduling unit 204. However, when an overlap further occurs in the other base station device 13 performing the coordinated communication, a spectrum in the relevant band is not deleted. The spectrum after the deletion is input to the equalization unit 502.

The decoding unit 902 executes error correction decoding on demodulated symbols input from the demodulation unit 505, and then outputs LLRs of coded bits after the decoding to the replica generation units 704-1 to -M.

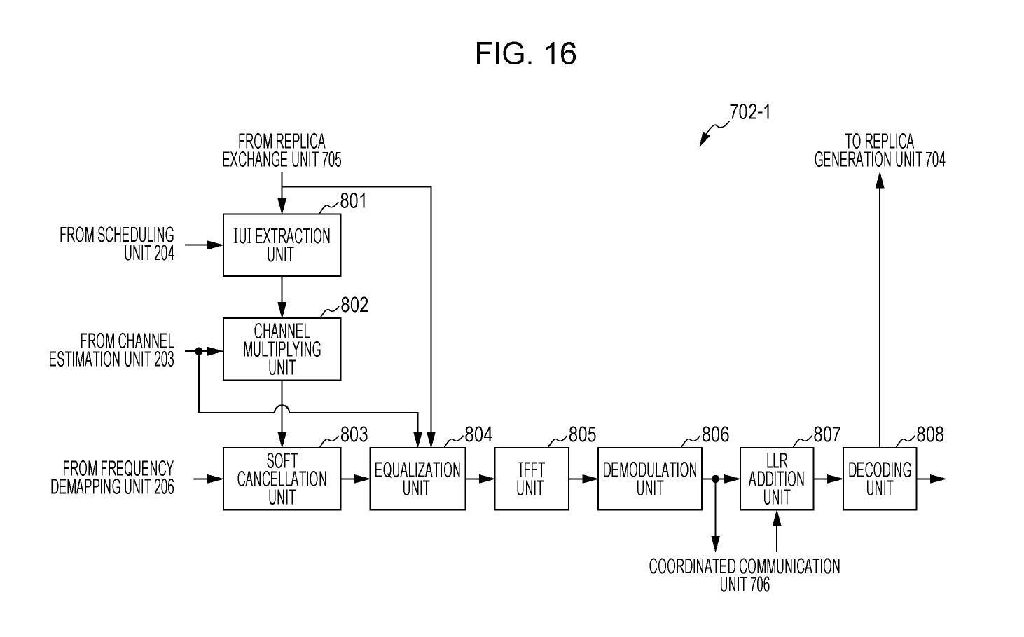

FIG. 16 is a schematic block diagram illustrating a configuration of the iterative processing unit 702-1. It is to be noted that, because the iterative processing units 702-2 to 702-M also have the same configuration as that of the iterative processing unit 702-1, description of the iterative processing units 702-2 to 702-M is omitted. The iterative processing unit 702-1 includes an IUI extraction unit 801, a channel multiplying unit 802, a soft cancellation unit 803, an equalization unit 804, an IFFT unit 805, a demodulation unit 806, an LLR addition unit 807, and a decoding unit 808.

The transmission replicas of all the mobile station devices 11 transmitting signals in a certain cell at the same time are input to the IUI extraction unit 801 from the replica exchange unit 205. The IUI extraction unit 801 extracts, from the input transmission replicas, a spectrum assigned to the same transmission band as that of a restored signal in accordance with the frequency assignment information input from the scheduling unit 204. Because the restored signal is a signal from the mobile station device 11 that is a processing target of the iterative reception processing unit 710 per mobile station, a transmission band of the restored signal is the assignment band assigned to the relevant mobile station device 11. Furthermore, the transmission replica of the restored signal is also included in the transmission replicas input to the IUI extraction unit 801. Therefore, the IUI extraction unit 801 extracts all the bands for the transmission replica of the restored signal. The reason is that, since the transmission replica of the restored signal itself is used to remove ISI (Inter-Symbol Interference), spectra of all the bands are required. The transmission replica of the restored signal itself may be input directly to the channel multiplying unit 802 from the replica generation units 704-1 to -M.

A channel characteristic of each mobile station device 11 is input to the channel multiplying unit 802 from the channel estimation unit 203. The channel multiplying unit 802 multiplies the spectrum of each transmission replica, which has been extracted by the IUI extraction unit 801, by the channel characteristic of the mobile station device 11 corresponding to that spectrum. The channel multiplying unit 802 adds all the multiplication results to generate a replica including IUI components of the received signals and a component of the restored signal itself. The channel multiplying unit 802 outputs the generated replica to the soft cancellation unit 803.

The soft cancellation unit 803 subtracts the replica, which has been input from the channel multiplying unit 802, from a signal (spectrum) input from the frequency demapping unit 206. As a result, the IUI components and the component of the restored signal itself are cancelled, and only a residual component is extracted. In the first process of the iterative processing, however, the replica input from the channel multiplying unit 802 is based on only the replicas generated through the coordinated communication mode processing units 701-1 to -M, and nothing is cancelled when the coordinated communication is not performed.

The equalization unit 804 executes an equalization process on the signal (residual component), which has been output from the soft cancellation unit 803, by employing the channel characteristic estimated by the channel estimating unit 203. Furthermore, the equalization unit 804 adds the transmission replica of the restored signal itself, which is input from the replica exchange unit 705, to the signal after the equalization process. Thus, the equalization unit 804 reconfigures a signal from which interference components caused by IUI interference and ISI interference, for example, have been removed. The equalization unit 804 outputs the reconfigured signal to the IFFT unit 805. However, when the replica of the restored signal itself is not present in the first process of the iterative processing, the signal after the equalization process is input to the IFFT unit 805. The IFFT unit 805 transforms the signal after the equalization process from a frequency domain signal to a time domain signal through IFFT. Moreover, the demodulation unit 806 executes a demodulation process of the time domain signal and generates LLRs of coded bits. It is to be noted that, since the functions of the equalization unit 804, the IFFT unit 805, and the demodulation unit 806 are respectively the same as those of the equalization unit 502, the IFFT unit 504, and the demodulation unit 505 of the coordinated communication mode processing unit 207-1 illustrated in FIG. 7, they may be each configured as the same circuit as that illustrated in FIG. 7.

In the case where the mobile station device 11 as the processing target of the iterative processing unit 702-1 is under the coordinated communication, the demodulation unit 806 transfers, through the coordinated communication unit 706 of the relevant base station device 13, the generated LLRs of the coded bits to the coordinated communication unit 706 of the other base station device 13, which is a partner of the coordinated communication. Furthermore, the demodulation unit 806 outputs the generated LLRs of the coded bits to the LLR addition unit 807. The LLR addition unit 807 adds the LLRs from the demodulation unit 806 to LLRs after demodulation in the reception device B, which is input through the coordinated communication unit 706, and then inputs the added LLRs to the decoding unit 808. In order to reduce a processing delay, the addition of the LLRs in the LLR addition unit 807 may be executed only after carrying out the iterative processing an arbitrary number of times instead of executing the addition per iterative processing. When the mobile station device 11 as the processing target is not under the coordinated communication, the LLR addition unit 807 executes nothing and outputs the LLRs of the coded bits generated by the demodulation unit 806, as they are, to the decoding unit 808.

While the diversity effect with the coordinated communication is obtained here by adding the LLRs after the demodulation, the diversity effect can also be obtained with an alternative process of averaging spectra in the frequency domain. In more detail, a spectrum averaging unit may be disposed between the equalization unit 804 and the IFFT unit 805. The spectrum averaging unit may exchange the spectrum output from the equalization unit 804 through the coordinated communication unit 706 between the base station devices 13, and may execute the process of averaging the spectrum after the equalization, which has been generated in the relevant base station device 13, and the spectrum after the equalization, which has been generated in the other base station device 13. The averaging process may be executed, for example, by a method of simply averaging the two spectra, or a method of averaging the two spectra with weights applied using respective channel characteristics.

The decoding unit 808 executes error correction decoding on the LLRs output from the LLR addition unit 807 to obtain the LLRs of information bits, i.e., bits before the coding, and the LLRs of the coded bits. The decoding unit 808 outputs the LLRs of the information bits to the determination unit 703-1, and outputs the LLRs of the coded bits to the replica generation unit 704-1. On that occasion, the LLRs are output to the determination unit 703 and the replica generation unit 704 corresponding to the same mobile station device 11 as the processing target such that the decoding unit 808 of the iterative processing unit 702-2 outputs the respective LLRs to the determination unit 703-2 and the replica generation unit 704-2, and that the decoding unit 808 of the iterative processing unit 702-3 outputs the respective LLRs to the determination unit 703-3 and the replica generation unit 704-3.

Returning to FIG. 14, the replica generation units 704-1 to -M receive the LLRs of the coded bits output respectively from the coordinated communication mode processing units 701-1 to -M after the processing in the coordinated communication mode processing units 701-1 to -M, and receive the LLRs of the coded bits respectively output from the iterative processing units 702-1 to -M after the processing in the iterative processing units 702-1 to -M. The replica generation units 704-1 to -M generate soft replicas (transmission replicas) corresponding to values of the LLRs by employing the input LLRs of the coded bits, and output the generated soft replicas to the replica exchange unit 705.

The soft replicas for the individual mobile station devices 11, which have been generated by the replica generation units 704-1 to -M, are all input to the replica exchange unit 705. The replica exchange unit 705 outputs the soft replicas to all the iterative processing units 702-1 to -M. The iterative processing units 702-1 to -M repeat the processing again by employing those soft replicas.

The LLRs of the information bits are input to the determination units 703-1 to -M from the iterative processing units 702-1 to -M, respectively. The determination units 703-1 to -M execute hard decision on the input LLRs and determine received data Rv-1a to -Ma. At that time, error detection may be executed using CRC (Cyclic Redundancy Check). If an error is detected, a retransmission process or an increase in the number of times of iterative processing, for example, may be additionally performed.

The reception process of data transmitted from the mobile station device 11 is executed through the above-described iterative processing.

Thus, by applying the nonlinear iterative equalization process to the base station device 13, a signal overlapping with that from the other mobile station device 11 can be separated while the diversity effect with the coordinated communication is obtained. Furthermore, because the application of the iterative equalization process enables IUI to be removed with the use of the error correction capability, signal separation can be performed in this embodiment even when overlaps with the other mobile station devices 11 occur in the same band in both the two base station device 13 performing the coordinated communication (such a state being called “multiple overlap”).

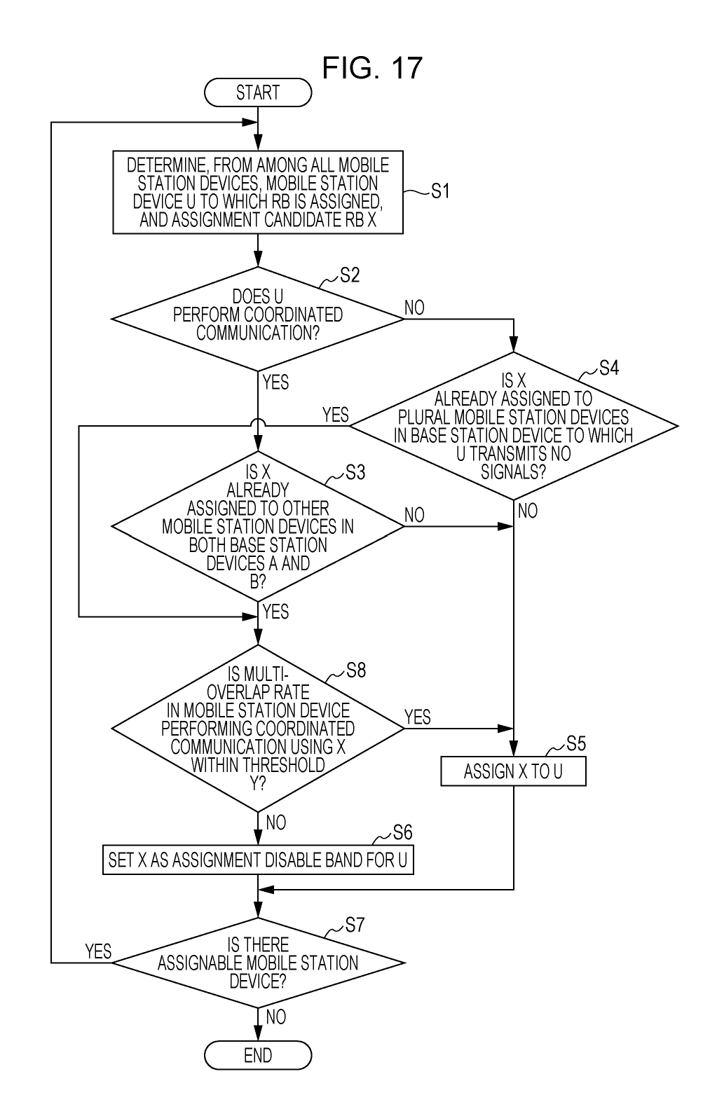

Therefore, the scheduling unit 204 in this embodiment may execute the frequency assignment in a similar manner to that in the first embodiment as illustrated in the flowchart of FIG. 9, or it may execute the frequency assignment in a modified manner as illustrated in a flowchart of FIG. 17. The flowchart of FIG. 17 is different from that of FIG. 9 in including step S8. Processes in other steps in FIG. 17 denoted by the same signs (S1 to S7) are the same as those in the corresponding steps in FIG. 9. However, if “Yes” is determined in step S3, and if “Yes” is determined in step S4, the processing is shifted to step S8 instead of step S6.

In step S8, the scheduling unit 204 calculates, as a multi-overlap rate, a rate at which a multiple-overlapped band occupies in the assignment band assigned to the mobile station device 11 performing the coordinated communication when the RB X is assigned to the mobile station device U. The scheduling unit 204 determines whether the multi-overlap rate is within a preset threshold Y. If the multi-overlap rate is within the threshold Y, the scheduling unit 204 shifts to step S5, and if it is greater than the threshold Y, the scheduling unit 204 shifts to step S6. By setting the threshold Y to zero, however, similar processing to that of the flowchart illustrated in FIG. 9 is obtained. In other words, when the threshold Y is set to a sufficiently large value, or when the threshold Y is not set, the mobile station device 11 performing the coordinated communication and the other mobile station device 11 can be overlapped with each other without limitation. Thus, by allowing bands to be assigned in overlapped relation between two reception devices, the scheduling can be made more flexible and the cell throughput can be increased.

In this embodiment, as described above, when the signal from the mobile station device 11 performing the coordinated communication and the signal from the mobile station device 11 not performing the coordinated communication are received in overlapped relation, the nonlinear iterative equalization using the soft canceller is applied to the reception process. At that time, the process of removing interference by the nonlinear iterative equalization can be efficiently made by executing the cancellation process in such a way that a replica of the signal having IUI as low as possible is generated in the first process of the iterative processing by employing the signals of the plural base station devices 13, which are obtained with the coordinated communication. As a result, the diversity effect with the coordinated communication can be obtained while degradation of communication quality caused by IUI is reduced.

### Third Embodiment

The first embodiment and the second embodiment have been described in connection with the case where two base station devices perform the coordinated communication between them through coordination. A third embodiment will be described in connection with the case where three base station devices receive a signal from one mobile station device via the coordinated communication.

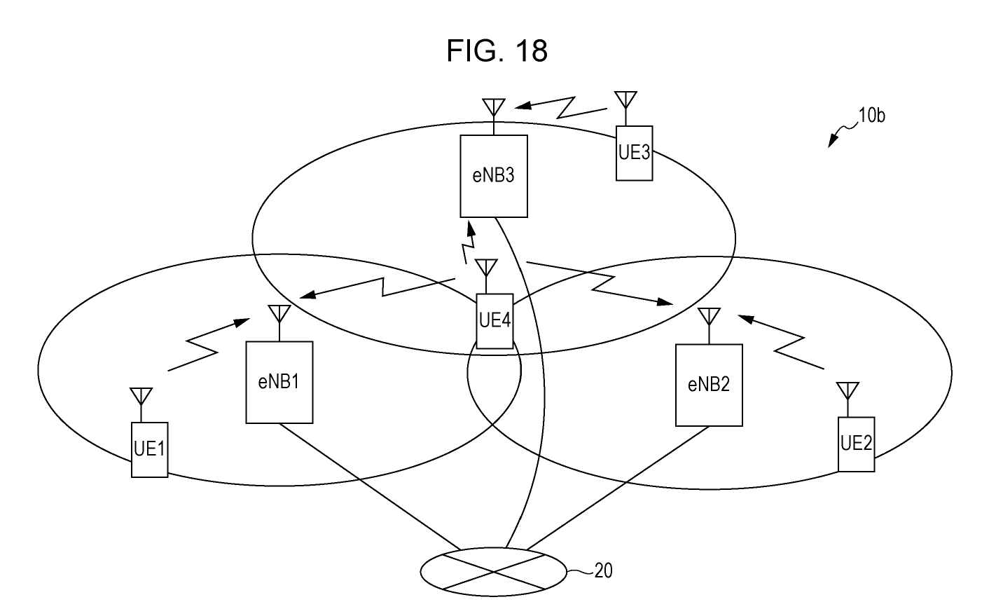

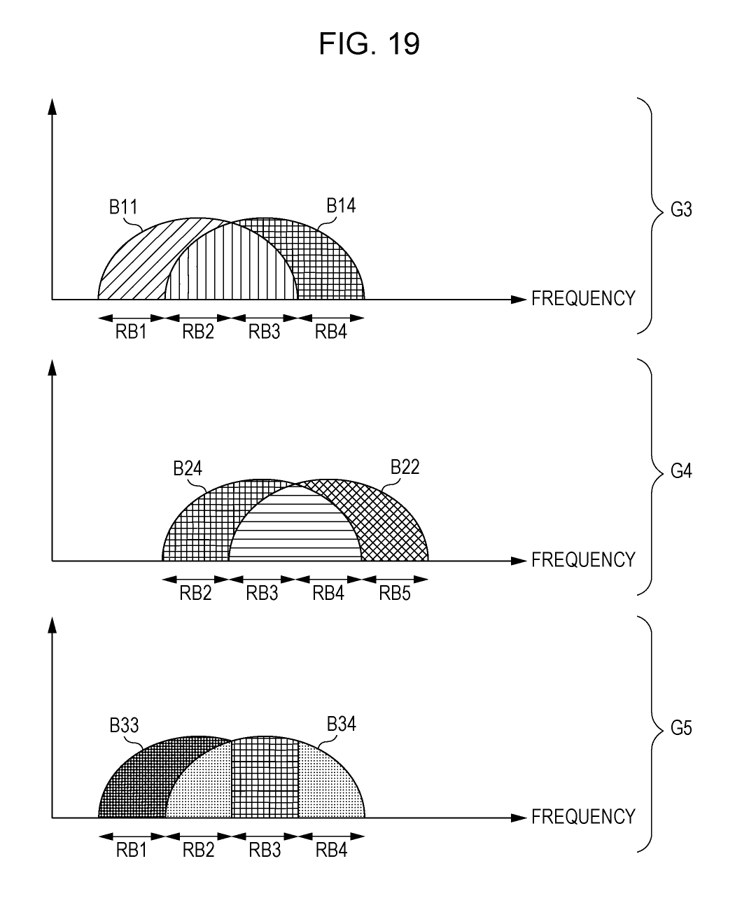

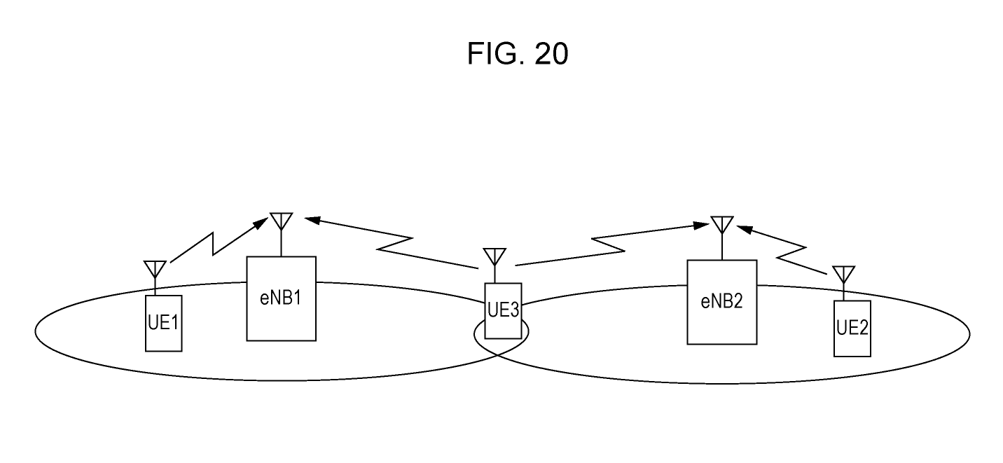

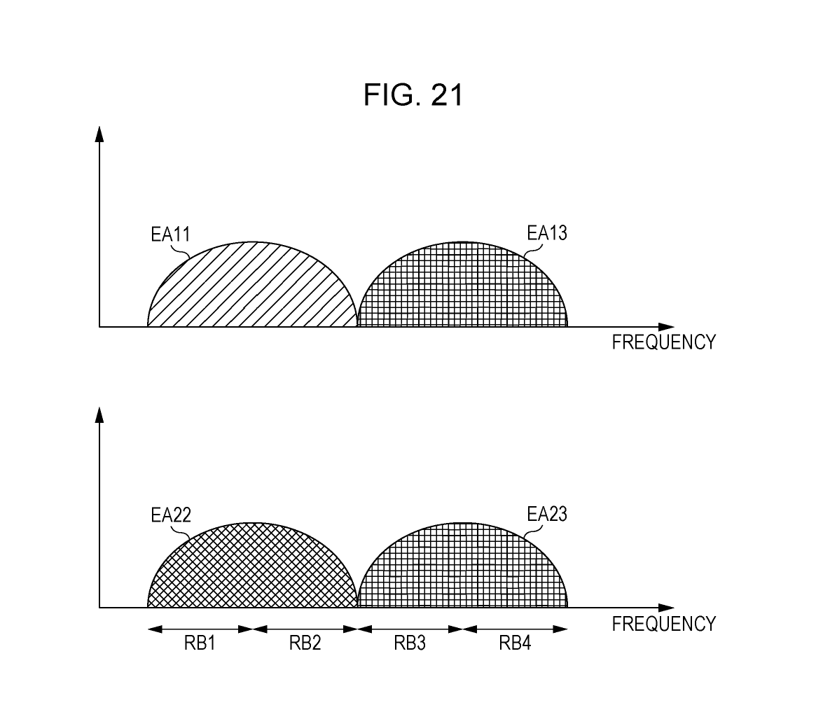

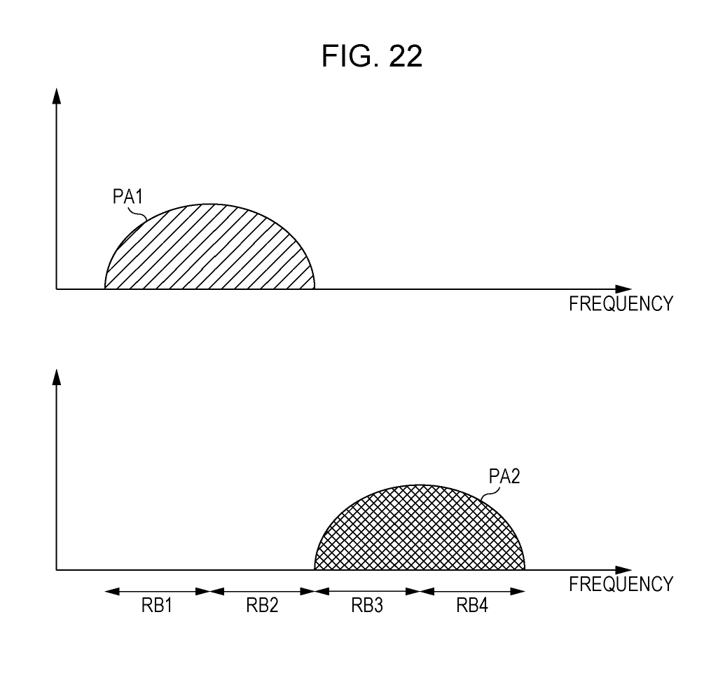

FIG. 18 is a conceptual view illustrating a configuration of a wireless communication system 10b according to this embodiment. Base station devices eNB1, eNB2 and eNB3 in this embodiment can perform the coordinated communication via wired communication, for example. In that environment, there are mobile station devices UE1, UE2, UE3 and UE4. UE1, UE2 and UE3 are present at positions where signals from UE1, UE2 are UE3 can be received respectively by eNB1, eNB2 and eNB3. UE4 is present at a position where a signal from UE4 can be received by all the three base station devices eNB1, eNB2 and eNB3. Because each of the mobile station devices UE1, UE2, UE3 and UE4 in this embodiment has the same configuration as that of any of the mobile station devices 11 in the first and second embodiments, description of the mobile station devices UE1, UE2, UE3 and UE4 is omitted.

In the case where the mobile station devices and the base station devices are positioned as illustrated in FIG. 18, when UE4 performs the coordinated communication by employing the three base station devices in accordance with the related-art technique, UE4 exclusively occupies a band in each cell. According to the related art, assuming a system band width to be 5RB, for example, when UE4 performs the coordinated communication using 3RB, bands assignable to each of UE1, UE2 and UE3 is 2RB, and wide-band transmission cannot be performed.

In contrast, in this embodiment, the scheduling unit 204 executes frequency assignment while allowing each of RBs, which constitute assignment bands assigned to the mobile station device UE4 performing the coordinated communication, to be overlapped with that assigned to the other mobile station devices 11 in cells up to two. Stated in another way, the scheduling unit 204 assigns frequency bands used for transmission from plural transmission devices such that each part of the frequency bands assigned to the mobile station device performing the coordinated communication is not overlapped with the frequency bands assigned to the other mobile station devices 11 in any one of the base station devices. FIG. 19 illustrates one example of frequency band assignment in the third embodiment. In FIG. 19, there are five assignable RBs, i.e., RB1 to RB5. An assignment plot G3 represents the assignment performed in eNB1. A spectrum B11 represents that RB1 to RB3 are assigned to UE1. Similarly, a spectrum B14 represents that RB2 to RB4 are assigned to UE4. An assignment plot G4 represents the assignment performed in eNB2. A spectrum B24 represents that RB2 to RB4 are assigned to UE4. Similarly, a spectrum B22 represents that RB3 to RB5 are assigned to UE2. An assignment plot G5 represents the assignment performed in eNB3. A spectrum B33 represents that RB1 to RB2 and RB4 are assigned in discrete layout to UE3. Similarly, a spectrum B34 represents that RB2 to RB4 are assigned to UE4. Thus, RB3 denoted by lattice-pattern hating is assigned to only UE4, and RB2 and RB4 denoted by dotted hatching are assigned to UE3 and UE4.

By executing the assignment as described above, in each base station device, the overlap occurs in 2RB, but the overlap does not occur in 1RB of the transmission band 3RB of UE4. In other words, RB2, RB3 and RB4 assigned to UE4 can be extracted as spectra not including IUI from eNB2, eNB3 and eNB1, respectively. Accordingly, the signal of UE4 can be restored from those spectra. Moreover, the signals of UE1, UE2 and UE3 can also be restored by canceling the overlap in each base station device with the use of the corresponding spectrum of UE4 without giving rise to degradation of quality caused by IUI. Thus, the band exclusively occupied by UE4 in each base station device is 1RB, and the transmission can be performed with the exclusively occupied band width reduced to ⅓ of that in the related art. Furthermore, it is also possible to overlap a partial spectrum of UE4 with those of the other mobile station devices in all the cells by employing the nonlinear iterative equalization process as in the second embodiment. In such a case, the band width occupied by UE4 in each call can be reduced to ⅓ or less of that in the related art.

Even when the number of base station devices coordinating with each other further increases, processing can be executed in a similar way. More specifically, when the coordinated communication is performed using a number N of base station devices, a part of the spectrum of the mobile station device performing the coordinated communication is set to be overlapped with parts of the spectra of the other mobile station devices in the number N−1 of base station devices. This can also suppress the influence of IUI by employing the not-overlapped spectrum received by the base station device. As a result of executing the above-described assignment, the band width occupied in each base station device can be reduced to 1/N of that in the related art not allowing the overlap.

The mobile station device in the third embodiment has the same configuration as that in the first embodiment illustrated in FIG. 4. Any of the configuration of FIG. 5 in the first embodiment and the configuration of FIG. 14 in the second embodiment can be applied to the base station device in the third embodiment. In the third embodiment, however, each of the coordinated communication unit 210 and the coordinated communication unit 706 shares information with all the base station devices performing the coordinated communication. Moreover, the scheduling unit 204 executes the frequency assignment as described above.

According to this embodiment, when a number X (X>2) of base station devices receive a signal from a certain mobile station device through the coordinated communication, a band exclusively occupied by the transmission device performing the coordinated communication can be reduced to 1/N without giving rise to degradation, which is caused by IUI, by allowing overlaps with signals from other mobile station devices per assignment unit in the number (X−1) of base station devices. Furthermore, in the case of employing the nonlinear iterative equalization process, the band occupied by the mobile station device performing the coordinated communication can be reduced to 1/N or less by allowing overlaps with signals from other mobile station devices in respective partial bands in all the base station devices.

The mobile station device 11 (FIG. 4) and the base station devices 12 (FIG. 5) and 13 (FIG. 14) in the above-described embodiments may be partly or entirely realized with the use of an LSI, typically an integrated circuit. Individual functional blocks of the mobile station device 11 and the base station device 12 or 13 may be separately integrated into chips, or may be partly or entirely integrated into chips. A method of forming the integrated circuit is not limited to the use of an LSI, and it may be practiced using a dedicated circuit or a universal processor. Furthermore, if a technique of realizing the integrated circuit instead of LSI will be developed with the progress of the semiconductor technology, it is also possible to use an integrated circuit obtained with the newly developed technique.

Programs for realizing respective functions of individual components in the mobile station device 11 of FIG. 4, the base station device 12 of FIG. 5, and the base station device 13 of FIG. 14 may be recorded on a computer-readable recording medium, and management of those devices may be performed by a computer system that reads and executes the programs recorded on the recording medium. The term “computer system” used here implies an OS and hardware such as peripheral devices.

When a www system is employed, the term “computer system” includes a homepage providing environment (or display environment) as well.

The term “computer-readable recording medium” implies a portable medium, such as a flexible disk, a magneto-optical disk, a ROM, and a CD-ROM, and a storage device, such as a hard disk incorporated in the computer system. Furthermore, the term “computer-readable recording medium” includes not only a member for dynamically holding programs for a short time, such as a communication wire used in transmitting programs via a network for, e.g., the Internet and a communication line, e.g., a telephone line, but also a member for holding programs for a certain time, such as a volatile memory in a computer system that operates as a server or a client in the case of transmitting the programs as mentioned above. The programs may be a program for realizing a part of the above-described functions, or may be a program capable of realizing any of the above-described functions in combination with a program that is already recorded in the computer system.

While the embodiments of the present invention have been described above with reference to the drawings, practical forms of the present invention are not limited to the foregoing embodiments, and the present invention involves various design changes, etc. within the scope not departing from the gist of the present invention.

### INDUSTRIAL APPLICABILITY

The present invention is suitably applied to a mobile communication system employing a cellular phone as a mobile station device, but application fields of the present invention are not limited thereto.

### DESCRIPTION OF REFERENCE NUMERALS

10, 10a, 10b . . . wireless communication systems
11, 11a, 11b, 11c . . . mobile station devices
12, 12a, 12b, 13 . . . base station devices
20 . . . core network
101 . . . coding unit
102 . . . modulation unit
103 . . . FFT unit
104 . . . frequency mapping unit
105 . . . IFFT unit
106 . . . reference signal multiplexing unit
107 . . . transmission processing unit
108 . . . antenna
109 . . . control information acquisition unit
110 . . . reference signal generation unit
111 . . . reception unit
201 . . . antenna
202 . . . reception unit
203 . . . channel estimation unit
204 . . . scheduling unit
205 . . . control information generation unit
206 . . . frequency demapping unit
207-1 . . . coordinated communication mode processing unit
209-1 . . . non-coordinated communication mode processing unit
210 . . . coordinated communication unit
211 . . . transmission unit
212 . . . antenna
220-1, 220-M . . . reception processing units each per mobile station
301 . . . reception processing unit
302 . . . reference signal demultiplexing unit
303 . . . FFT unit
501, 901 . . . overlapped spectrum deletion units
502 . . . equalization unit
503 . . . spectrum combining unit
504 . . . IFFT unit
505 . . . demodulation unit
507, 902 . . . decoding units
601 . . . overlapped spectrum extraction unit
602 . . . channel multiplying unit
603 . . . overlap cancellation unit
604 . . . equalization unit
605 . . . IFFT unit
606 . . . demodulation unit
607 . . . decoding unit
701-1 . . . coordinated communication mode processing unit
702-1 . . . iterative processing unit
703-1 . . . determination unit
704-1 . . . replica generation unit
705 . . . replica exchange unit
706 . . . coordinated communication unit
710-1, 710-M . . . reception processing units each per mobile station
801 . . . IUI extraction unit
802 . . . channel multiplying unit
803 . . . soft cancellation unit
804 . . . equalization unit
805 . . . IFFT unit
806 . . . demodulation unit
807 . . . LLR addition unit
808 . . . decoding unit

1. A reception device receiving a signal from a transmission device in coordination with at least one other reception device, the reception device comprising:
a reception unit that receives the signal transmitted from the transmission device;
a coordinated communication unit that, when a part of a frequency band of the signal transmitted from the transmission device is overlapped with a frequency band of a signal transmitted from another transmission device, receives from the other reception device a spectrum in at least a part of the overlapped frequency band of the signal transmitted from the transmission device; and
a first reception processing unit that executes a reception process of the signal received by the reception unit by employing the spectrum received by the coordinated communication unit.

2. The reception device according to claim 1, further comprising a scheduling unit that determines a first frequency band used in transmission by the transmission device,
wherein the scheduling unit determines the first frequency band to be not overlapped per assignment unit with one of a second frequency band used by the other transmission device transmitting the signal to the relevant reception device and a third frequency band used by the other transmission device transmitting a signal to the other reception device.

3. The reception device according to claim 1, wherein the first reception processing unit includes a spectrum combining unit that combines a spectrum of the signal received by the reception unit and the spectrum received by the coordinated communication unit.

4. The reception device according to claim 3, wherein the first reception processing unit includes a replica generation unit that generates a replica of the signal transmitted from the transmission device based on the spectrum combined by the spectrum combining unit, and
a cancellation unit that cancels an interference component of the signal received by the reception unit by employing the generated replica.

5. The reception device according to claim 1, further comprising a second reception processing unit that executes a reception process of the signal transmitted from the other transmission device,
wherein the reception unit receives, in addition to the signal transmitted from the transmission device, the signal transmitted from the other transmission device, the latter signal having the frequency band that includes a frequency band of the spectrum received by the coordinated communication unit, and
the second reception processing unit includes an overlap cancellation unit that cancels the spectrum received by the coordinated communication unit from a spectrum of the signal received by the reception unit, the latter spectrum being a spectrum in the frequency band of the signal transmitted from the other transmission device.

6. The reception device according to claim 5, wherein the first reception processing unit includes a replica generation unit that generates a replica of the signal transmitted from the transmission device based on the spectrum combined by the spectrum combining unit, and
the second reception processing unit includes a cancellation unit that cancels an interference component of the spectrum of the signal received by the reception unit, the spectrum being the spectrum in the frequency band of the signal transmitted from the other transmission device, by employing the generated replica.

7. The reception device according to claim 1, wherein the other reception device exists plural,
and the coordinated communication unit receives, from each of the plural other reception devices, at least a part of the spectrum in the overlapped frequency band of the signal transmitted from the transmission device.

8. A reception method for use in a reception device receiving a signal from a transmission device in coordination with at least one other reception device, the reception method comprising:
a first step of receiving the signal transmitted from the transmission device;
a second step of, when a part of a frequency band of the signal transmitted from the transmission device is overlapped with a frequency band of a signal transmitted from another transmission device, receiving from the other reception device at least a part of a spectrum in the overlapped frequency band of the signal transmitted from the transmission device; and
a third step of executing a reception process of the signal received in the first step by employing the spectrum received in the second step.

9. (canceled)

10. A wireless communication system comprising a first reception device and a second reception device both receiving a signal from a transmission device through coordination,
wherein the first reception device comprises:
a first reception unit that receives the signal transmitted from the transmission device; and
a first coordinated communication unit that transmits, to the second reception device, a partial spectrum in at least a part of a frequency band of the received signal, which is overlapped with a frequency band of a signal transmitted from another transmission device to the second reception device, and
wherein the second reception device comprises:
a second reception unit that receives the signal transmitted from the transmission device;
a second coordinated communication unit that receives the partial spectrum; and
a reception processing unit that executes a reception process of the signal received by the second reception unit by employing the partial spectrum.
